(19) United States
(12) Patent Application Publication
(10) Pub. No.: US 2025/0371371 A1
(43) Pub. Date: Dec. 4, 2025

(54) METHODS AND SYSTEMS FOR COMPLEMENTARITY-ADJUSTED FEDERATED AVERAGING IMPUTATION

(71) Applicant: Rutgers, The State University of New Jersey, New Brunswick, NJ (US)

(72) Inventors: Sitao Min, Harrison, NJ (US); Jaideep S. Vaidya, East Brunswick, NJ (US); Hafiz Asif, Brooklyn, NY (US); Xinyue Wang, Harrison, NJ (US)

(73) Assignee: Rutgers, The State University of New Jersey, New Brunswick, NJ (US)

(21) Appl. No.: 19/222,631

(22) Filed: May 29, 2025

Related U.S. Application Data
(60) Provisional application No. 63/652,987, filed on May 29, 2024.

(51) Int. Cl. G06N 3/098; G06N 3/0464

(52) U.S. Cl. CPC G06N 3/098; G06N 3/0464

(57) ABSTRACT

A method and system are disclosed for federated imputation of missing data in distributed machine learning environments, particularly under complex missingness scenarios. The disclosed approach utilizes the complementarity of both observable and missing data distributions across multiple clients. Missing value patterns encoded within each local dataset are exploited to compute a Complementarity-Adjusted Federated Averaging (Cafe) of local imputation models. The resulting complementarity scores are then employed to generate personalized imputation models for individual clients, thereby enhancing imputation accuracy while preserving data privacy. The method is applicable in settings where data cannot be shared directly due to confidentiality constraints. Empirical results demonstrate that the Cafe approach achieves substantial performance improvements over centralized imputation techniques and existing state-of-the-art federated imputation baselines.

### CROSS-REFERENCE TO RELATED APPLICATIONS

This application claims priority under 35 U.S.C. § 119(e) to U.S. Provisional Patent Application No. 63/652,987, filed May 29, 2024. The foregoing application is incorporated by reference herein in its entirety.

### STATEMENT REGARDING FEDERALLY SPONSORED RESEARCH

This invention was made with government support under Grant Nos. GM134927 and LM014520 awarded by the National Institutes of Health. The government has certain rights in the invention.

### FIELD

This invention relates generally to methods and systems for complementarity-adjusted federated averaging imputation.

### BACKGROUND

Today, data is collected by commercial, governmental, and even non-governmental organizations in all settings and is often collected at various institutional sites. For example, healthcare data may be collected by primary care physicians, hospitals, insurance companies, pharmacies, and other organizations. Due to a number of reasons, including regulatory compliance, institutional autonomy, confidentiality concerns, or even simply economic reasons, this data is not (and, in fact, often cannot be) shared in raw form or processed at a central site. Thus, modern machine learning or artificial intelligence models cannot be applied directly over this data, effectively prohibiting applications such as fraud detection, diagnosis of rare diseases, or identification of adverse effects. Federated learning (FL), which allows the building of models over distributed data, is rapidly gaining popularity as an alternative to data centralization and the creation of data silos. In federated learning, models are locally built over the distributed data, and then aggregated at a central site. This mitigates many concerns with maintaining institutional autonomy, raw data confidentiality, and regulatory compliance, and even limits computational and communication costs, which are quite significant for large quantities of data.

A critical preliminary step in machine learning over real data, whether centralized or federated, is data pre-processing or cleaning, particularly handling the missing values in the data, which often occurs in real life. However, federated learning typically relies on complete data (i.e., without any missing values). Despite popularity of federated learning, the problem of processing missing values in a federated manner is not well studied or understood.

Therefore, there remains a need for improved methods and systems for federated data imputation.

### SUMMARY

This disclosure addresses the need mentioned above in a number of aspects. In one aspect, this disclosure presents a method for complementarity-adjusted federated averaging imputation, comprising: (a) receiving, by a server device, a missing mechanism prediction model and a local data imputation model from each of a set of user devices, wherein the missing mechanism prediction model of a user device determines missing data of a feature in a dataset of the user device, and wherein the local data imputation model of the user device is configured to impute the missing data of the feature to the dataset of the user device; (b) determining, by the server device, a complementarity score of the feature for the missing mechanism prediction model in each of the set of user devices based on pair-wise complementarity of data available for the feature in each of the user devices relative to the missing data for the feature of a reference user device in the set of user devices; (c) generating for the feature by the server device an individualized federated averaging data imputation model specific to each of the set of user devices by performing complementarity-adjusted federated averaging on local data imputation models received from the set of user devices, wherein the complementarity-adjusted federated averaging comprises aggregating the local data imputation models and applying a weight to each of the local data imputation models based on the complementarity score of a corresponding missing mechanism prediction model; (d) transmitting to each of the set of the user device the individualized federated averaging data imputation model specific to each of the set of the user devices, and updating the local data imputation model of each of the set of the user device based on the individualized federated averaging data imputation model; and (e) imputing the missing data of the feature to the dataset of each of the set of the user devices by the updated local data imputation model.

In some embodiments, the method comprises performing one or more iterations of steps (a)-(e) until the local data imputation model from an iteration converges with the local data imputation model from a succeeding iteration.

In some embodiments, the method comprises determining the pairwise complementarity by Imputation via Chained Equations (ICE) modeling.

In some embodiments, the method comprises imputing the missing data with a mean or median value.

In some embodiments, the method comprises performing one or more iterations of steps (a)-(e) for missing data of one or more features in the dataset.

In some embodiments, the local data imputation model comprises a linear regression model. In some embodiments, the local data imputation model comprises a ridge regression model.

In some embodiments, the missing mechanism prediction model comprises a logistic regression model. In some embodiments, the missing mechanism prediction model or the local data imputation model comprises a machine learning model.

In some embodiments, the missing mechanism prediction model or the local data imputation model comprises a neural network, a convolutional neural network (CNN), a deep convolutional neural network (DCNN), a cascaded deep convolutional neural network, a simplified CNN, a shallow CNN, or a combination thereof.

In some embodiments, the method comprises identifying a subset of user devices as likely having data that complements the missing data of the feature in the user device.

In some embodiments, the method comprises performing one or more iterations of steps (a)-(e) on the subset of user devices for the missing data of the feature in the user device.

In some embodiments, the missing data comprises non-identically distributed data. In some embodiments, the missing data comprises data missing completely at random (MCAR), data missing at random (MAR), or data missing not at random (MNAR). In some embodiments, the missing data comprises non-MCAR data that a missing data distribution depends on an observable data distribution. In some embodiments, the missing data comprises non-MCAR data that a missing data distribution depends on an unobservable data distribution.

In some embodiments, at least a subset of user devices in the set of user devices are located in different sites.

In some embodiments, the server device comprises one or more distributed units.

In some embodiments, data of the user device is not shared with another user device or the server device.

In some embodiments, the method comprises determining a pair-wise complementarity score by:

$$Complementarity Score = \frac{1}{2} ( 1 - \frac{< {ξ}_{f}^{k} , {ξ}_{f}^{ℓ} >}{‖ {ξ}_{f}^{k} ‖ \cdot ‖ {ξ}_{f}^{ℓ} ‖} )$$

where

$${ξ}_{f}^{k} and {ξ}_{f}^{l}$$

denote the parameters of the missing mechanism models for feature f of client k and l, respectively, <⋅> denotes the vector product and ∥⋅∥ denotes the vector norm.

In some embodiments, the method comprises determining a sample size-based complementarity score by:

$${s}^{l} = {N}_{f}^{l} / {M}_{f} and {M}_{f} = max {N}_{f}^{1} , {N}_{f}^{2} , … , {N}_{f}^{n}$$

where

$${N}_{f}^{1} … {N}_{f}^{n}$$

are sample size of each client. s^{l} is the sample size score of client l.

In some embodiments, the method comprises determining a weighted average of the complementarity score by:

$${a}^{k ℓ} ∝ α ( \begin{matrix}No . of f - observable \\ samples at ℓ\end{matrix} ) + ( 1 - α ) ( \begin{matrix}complementarity b / w \\ {ξ}_{f}^{k} and {ξ}_{f}^{ℓ}\end{matrix} )$$

where [symbol] is the weighted average of the score, α∈[0,1] denotes the weight assigned to the sample size-based score, which controls the relative importance/influence of sample size versus complementarity.

In some embodiments, the method comprises determining a normalized weighted average of the complementarity score by:

$${w}^{kl} = {( {a}^{kl} )}^{β} / {\sum }_{j \neq k} {( {a}^{kj} )}^{β}$$

where w^{kl} is normalized weighted averaging of the complementarity score, a^{kl} is weighted averaging score, β is scale for normalization.

In some embodiments, the method comprises determining the individualized federated averaging data imputation model by:

$$Cafe - Av g ( k , f ) = γ \cdot {θ}_{f}^{k} + ( 1 - γ ) {\sum }_{ℓ \neq k} {w}^{k ℓ} \cdot {θ}_{f}^{ℓ}$$

where

$${θ}_{f}^{k}$$

denotes the parameters of the imputation model for feature f of client k, [symbol] denotes the weighted average of the complementarity score, and γ is the hyper parameter to control the relative influence of the local model and the weighted averaged global model.

In another aspect, this disclosure provides a system for complementarity-adjusted federated averaging imputation. In some embodiments, the system comprises one or more processors configured to implement the method as described herein.

The foregoing summary is not intended to define every aspect of the disclosure, and additional aspects are described in other sections, such as the following detailed description. The entire document is intended to be related as a unified disclosure, and it should be understood that all combinations of features described herein are contemplated, even if the combinations of features are not found together in the same sentence, or paragraph, or section of this document. Other features and advantages of the invention will become apparent from the following detailed description. It should be understood, however, that the detailed description and the specific examples, while indicating specific embodiments of the disclosure, are given by way of illustration only, because various changes and modifications within the spirit and scope of the disclosure will become apparent to those skilled in the art from this detailed description.

### BRIEF DESCRIPTION OF THE DRAWINGS

FIG. 1 shows the impact of heterogeneous non-MCAR missing data. The left and right panels display datasets from Client 1 and Client 2, respectively, illustrating missing values and observed values across three features (f1, f2, f3) governed by Missing Mechanisms M1 and M2. Histograms depict the distributions of observed and missing values for each variable, while the scatter plots reveal the inter-variable relationships under conditions of missing data. Even though the sampled data is iid, the effect of the missing mechanisms is to make the observed data at each client non-iid. The complementarity nature of the missing data between clients can be clearly seen; specifically, Client 1's observed data distribution can potentially inform the imputation of Client 2's missing data and vice versa. Such complementarity underscores the potential of a federated learning framework to enhance imputation quality using data from clients with complementary missing mechanisms. Note that orange dots in the scatter plots represent data points where both features on the X and Y axes are observed.

FIG. 2 shows an example ICE Algorithm.

FIG. 3 shows an example process of Complementarity-adjusted Federated (Cafe) Imputation. This figure illustrates Cafe Averaging of imputation models from clients for one feature at each iteration. The whole process follows the following steps: (1) Clients fit the imputation and mechanism models, (2) Clients upload both models and mechanism to the server, (3) Server conducts Cafe averaging, (4) Server dispatches personalized aggregated imputation models to the clients, (5) Clients use updated imputation models to impute their local missing data, and continue with the next iteration, if necessary.

FIGS. 4a and 4b show t-SNE Visualization for imputed vs. ground-truth data. Each subplot presents a scatter plot projection of the ground-truth data and the imputed data over the merged data from all clients for the Codon task. A greater overlap between red and points signifies better imputation quality. FIG. 4a shows Complex Scenario #1 (quantile-based mechanism), and FIG. 4b shows Complex Scenario #2 (logit-based mechanism).

FIGS. 5a and 5b show imputation error convergence curves. Each line depicts the average imputation error across all clients. FIG. 5a shows Complex Scenario #1 (quantile-based mechanism), and FIG. 5b shows Complex Scenario #2 (logit-based mechanism)

FIG. 6 shows pairwise complementarity. The heatmap plots the pairwise complementarity scores for missing mechanism models across clients (for Codon, exemplified by one feature; other features have similar results). From Ideal to S4, the level of complementarity decreases. Here, blue hues indicate high complementarity, red indicates pretty low complementarity, and yellow and green hues indicate moderate levels.

FIG. 7 shows evaluation of different levels of missing mechanism complementarity. Scenarios (Ideal, S1-S4) are ordered in decreasing levels of missing mechanism complementarity.

FIG. 8 shows evaluation on different sample size strategies.

FIG. 9 shows federated imputation RMSE (complex scenarios).

FIG. 10 shows federated prediction F1 score (complex scenarios).

FIG. 11 shows evaluation with varying numbers of perfectly complementary clients. Each line represents the average imputation errors. Here, one client has MNAR-Left (ρ=0.5) and N−1 have MNAR-Right (ρ=0.5). For N=1, the error is for local imputation alone.

FIG. 12 shows an example computer system for implementing the disclosed methods.

### DETAILED DESCRIPTION

Federated learning (FL), a decentralized approach to training machine learning models, offers great performance while assuaging autonomy and confidentiality concerns. However, federated learning assumes that there is no missingness in data, which is almost never the case. Despite FL's popularity, the problem of processing missing values in a federated manner is not well studied or understood. This disclosure describes a method for federated imputation of missing values, particularly in complex scenarios, and provides a solution based on complementarity of observable as well as missing data distribution across clients. The information missing values encoded in each local dataset is leveraged to compute complementarity-adjusted federated (Cafe) averaging of the local imputation models. The computed complementarity scores are used to develop personalized imputation models for each client. An extensive empirical evaluation demonstrates that Cafe significantly outperforms state-of-the-art baselines and centralized imputation.

### Methods and Systems for Complementarity-Adjusted Federated Averaging Imputation

This disclosure provides novel methods and systems for complementarity-adjusted federated averaging imputation, comprising: (a) receiving, by a server device, a missing mechanism prediction model and a local data imputation model from each of a set of user devices, wherein the missing mechanism prediction model of a user device determines missing data of a feature in a dataset of the user device, and wherein the local data imputation model of the user device is configured to impute the missing data of the feature to the dataset of the user device; (b) determining, by the server device, a complementarity score of the feature for the missing mechanism prediction model in each of the set of user devices based on pair-wise complementarity of data available for the feature in each of the user devices relative to the missing data for the feature of a reference user device in the set of user devices; (c) generating for the feature by the server device an individualized federated averaging data imputation model specific to each of the set of user devices by performing complementarity-adjusted federated averaging on local data imputation models received from the set of user devices, wherein the complementarity-adjusted federated averaging comprises aggregating the local data imputation models and applying a weight to each of the local data imputation models based on the complementarity score of a corresponding missing mechanism prediction model; (d) transmitting to each of the set of the user device the individualized federated averaging data imputation model specific to each of the set of the user devices, and updating the local data imputation model of each of the set of the user device based on the individualized federated averaging data imputation model; and (e) imputing the missing data of the feature to the dataset of each of the set of the user devices by the updated local data imputation model.

In some embodiments, the method comprises performing one or more iterations of steps (a)-(e) until the local data imputation model from an iteration converges with the local data imputation model from a succeeding iteration.

In some embodiments, the method comprises determining the pairwise complementarity by Imputation via Chained Equations (ICE) modeling. ICE is sometimes referred to as Multiple Imputation by Chained Equations (MICE), a technique for handling missing data in statistical analysis. ICE is a form of multiple imputation. The core idea is to create multiple versions (typically 5-20) of the dataset where the missing values have been filled in using a statistical procedure. Then, the analysis of interest (like linear regression, logistic regression, etc.) is performed on each imputed dataset, and the results are subsequently combined to get a more robust overall estimate. ICE works by iteratively imputing missing values in each variable one at a time. For each variable with missing values, a separate imputation model is created. This model predicts the missing values based on the other variables in the dataset (the variables with complete data for that specific observation). The imputation models are applied sequentially. To impute a missing value in a specific variable, the model for that variable is used, considering the already imputed values for the other variables in that observation. This process is repeated multiple times, resulting in multiple complete datasets where the missing values have been replaced with imputed values.

The advantages of ICE include flexibility, relatively easy implementation, improved power, and reduced bias. ICE can handle various data types (numerical, categorical) and can be applied to datasets with missing values in multiple variables. By incorporating uncertainty about missing values through multiple imputations, ICE can lead to more reliable statistical inferences.

In some embodiments, the method comprises imputing the missing data with a mean or median value.

In some embodiments, the method comprises performing one or more iterations of steps (a)-(e) for missing data of one or more features in the dataset.

In some embodiments, the local data imputation model comprises a linear regression model. A linear regression model is a statistical technique used to uncover the relationship between a dependent variable (what is to be predicted) and one or more independent variables (what the prediction is based on). It essentially creates a best-fit straight line through a set of data points. There are two main types of linear regression, including simple linear regression and multiple linear regression. Simple linear regression involves only one independent variable. The model outputs a straight line that represents the linear relationship between the independent variable and the dependent variable. Multiple linear regression involves two or more independent variables. The model outputs a hyperplane (a higher dimensional version of a flat plane) that represents the relationship between the multiple independent variables and the dependent variable.

In some embodiments, the local data imputation model comprises a ridge regression model. Ridge regression is a specific type of linear regression model that addresses a common problem in linear regression: multicollinearity. Multicollinearity occurs when independent variables in a linear regression model are highly correlated with each other. This can lead to unstable estimates of the coefficients (slopes) in the model, making the model unreliable for prediction and interpretation. Ridge regression is also a technique that uses regularization to address multicollinearity. Regularization penalizes models with large coefficients, essentially shrinking them towards zero. This reduces the influence of any individual highly correlated variable and makes the model more stable.

In some embodiments, the missing mechanism prediction model comprises a logistic regression model. Logistic regression is a statistical method used for classification tasks. Unlike linear regression, which predicts continuous values, logistic regression estimates the probability of an event happening, typically resulting in a binary outcome (yes/no, 0/1). Logistic regression uses a linear regression model, but instead of directly predicting the outcome, it transforms the linear relationship into a probability using the logistic function (also called the sigmoid function). This S-shaped function squishes the linear model's output between 0 and 1, making it suitable for probability estimation.

In some embodiments, the missing mechanism prediction model or the local data imputation model comprises a machine learning model.

As used herein, a “machine learning model,” a “model,” or a “classifier” refers to a set of algorithmic routines and parameters that can predict an output(s) for a process input based on a set of input features, with or without being explicitly programmed. A structure of the software routines (e.g., number of subroutines and relation between them) and/or the values of the parameters can be determined in a training process, which can use actual results of the process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology. A neural network or an artificial neural network is one set of algorithms used in machine learning for modeling the data using graphs of neurons. Any network structure may be used. Any number of layers, nodes within layers, types of nodes (activations), types of layers, interconnections, learnable parameters, and/or other network architectures may be used. Machine training uses the defined architecture, training data, and optimization to learn values of the learnable parameters of the architecture based on the samples and ground truth of training data.

A typical machine learning pipeline may include building a machine learning model from a sample dataset (referred to as a “training set”), evaluating the model against one or more additional sample datasets (referred to as a “validation set” and/or a “test set”) to decide whether to keep the model and to benchmark how good the model is, and using the model in “production” to make predictions or decisions against live input data captured by an application service. For training the model to be applied as a machine-learned model, training data is acquired and stored in a database or memory. The training data is acquired by aggregation, mining, loading from a publicly or privately formed collection, transfer, and/or access. Ten, hundreds, or thousands of samples of training data are acquired. The samples are from scans of different patients and/or phantoms. Simulation may be used to form the training data. The training data includes the desired output (ground truth), such as segmentation, and the input, such as protocol data and imaging data.

In some embodiments, the training set will be used to create a single classifier using any now or hereafter-known methods. In other embodiments, a plurality of training sets will be created to generate a plurality of corresponding classifiers. Each of the plurality of classifiers can be generated based on the same or different learning algorithm that utilizes the same or different features in the corresponding one of the pluralities of training sets.

Once trained, the machine-learned or trained classifier is stored for later application. The training determines the values of the learnable parameters of the network. The network architecture, values of non-learnable parameters, and values of the learnable parameters are stored as the machine-learned network. Once stored, the machine-learned network may be fixed. The same machine-learned network may be applied to different patients, different scanners, and/or with different imaging protocols for the scanning. The machine-learned network may be updated. As additional training data is acquired, such as through application of the network for patients and corrections by experts to that output, the additional training data may be used to re-train or update the training.

For the machine learning model, input data structures of subreads can be used for the training. The training is performed by optimizing parameters of the model based on outputs of the model matching or not matching corresponding labels of the first labels and optionally the second labels when the first plurality of first data structures and optionally the second plurality of second data structures are input to the model.

In some embodiments, the machine learning model may further include a supervised learning model. Supervised learning models may include different approaches and algorithms including analytical learning, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, Nearest Neighbor Algorithm, probably approximately correct learning (PAC) learning, ripple down rules, a knowledge acquisition methodology, symbolic machine learning algorithms, subsymbolic machine learning algorithms, support vector machines, Minimum Complexity Machines (MCM), random forests, ensembles of classifiers, ordinal classification, data pre-processing, handling imbalanced datasets, statistical relational learning, or Proaftn, a multicriteria classification algorithm, linear regression, logistic regression, deep recurrent neural network (e.g., long short term memory, LSTM), Bayes classifier, hidden Markov model (HMM), linear discriminant analysis (LDA), k-means clustering, density-based spatial clustering of applications with noise (DBSCAN), random forest algorithm, support vector machine (SVM), or any model described herein.

In some embodiments, the classifier may include a supervised or unsupervised Machine Learning or Deep Learning algorithm, Logistic Regression, Naive Bayes, Support Vector Machine, Decision Tree, Random Forest, Gradient Boosting, Regularizing Gradient Boosting, K-Nearest Neighbors, a continuous regression approach, Ridge Regression, Kernel Ridge Regression, Support Vector Regression, deep learning approach, Neural Networks, Convolutional Neural Network (CNNs), Recurrent Neural Networks (RNNs), Gated Recurrent Units (GRUs), Long Short Term Memory Networks (LSTMs), Generative Models, Generative Adversarial Networks (GANs), Deep Belief Networks (DBNs), Feedforward Neural Networks, Autoencoders, Variational Autoencoders, Normalizing Flow Models, Deniosing Diffusion Probabilistic Models (DDPMs), Score Based Generative Models (SGMs), Radial Basis Function Networks (RBFNs), Multilayer Perceptrons (MLPs), Stochastic Neural Networks, or any combination thereof.

In some embodiments, the model may include a convolutional neural network (CNN). The CNN may include a set of convolutional filters configured to filter the first plurality of data structures and, optionally, the second plurality of data structures. The filter may be any filter described herein. The number of filters for each layer may be from 10 to 20, 20 to 30, 30 to 40, 40 to 50, 50 to 60, 60 to 70, 70 to 80, 80 to 90, 90 to 100, 100 to 150, 150 to 200, or more. The kernel size for the filters can be 2, 3, 4, 5, 6, 7, 8, 9, 10, 11, 12, 13, 14, 15, from 15 to 20, from 20 to 30, from 30 to 40, or more. The CNN may include an input layer configured to receive the filtered first plurality of data structures and, optionally, the filtered second plurality of data structures. The CNN may also include a plurality of hidden layers, including a plurality of nodes. The first layer of the plurality of hidden layers is coupled to the input layer. The CNN may further include an output layer coupled to a last layer of the plurality of hidden layers and configured to output an output data structure. The output data structure may include the properties.

As used herein, the terms or acronyms like “convolutional neural network,” “CNN,” “neural network,” “NN,” “deep neural network,” “DNN,” “recurrent neural network,” “RNN,” and/or the like may be interchangeably referenced throughout this document.

In some embodiments, the missing mechanism prediction model or the local data imputation model comprises a neural network, a convolutional neural network (CNN), a deep convolutional neural network (DCNN), a cascaded deep convolutional neural network, a simplified CNN, a shallow CNN, or a combination thereof.

In some embodiments, the method comprises identifying a subset of user devices as likely having data that complements the missing data of the feature in the user device.

In some embodiments, the method comprises performing one or more iterations of steps (a)-(e) on the subset of user devices for the missing data of the feature in the user device.

In some embodiments, the missing data comprises non-identically distributed data. In some embodiments, the missing data comprises data missing completely at random (MCAR), data missing at random (MAR), or data missing not at random (MNAR). In some embodiments, the missing data comprises non-MCAR data that a missing data distribution depends on an observable data distribution. In some embodiments, the missing data comprises non-MCAR data that a missing data distribution depends on an unobservable data distribution.

In some embodiments, at least a subset of user devices in the set of user devices are located in different sites.

In some embodiments, the server device comprises one or more distributed units.

In some embodiments, data of the user device is not shared with another user device or the server device.

In some embodiments, the method comprises determining a pair-wise complementarity score by:

$$Complementarity Score = \frac{1}{2} ( 1 - \frac{< {ξ}_{f}^{k} , {ξ}_{f}^{ℓ} >}{‖ {ξ}_{f}^{k} ‖ \cdot ‖ {ξ}_{f}^{ℓ} ‖} )$$

where

$${ξ}_{f}^{k} and {ξ}_{f}^{l}$$

denote the parameters of the missing mechanism models for feature f of client k and l, respectively, <⋅> denotes the vector product and ∥⋅∥ denotes the vector norm.

In some embodiments, the method comprises determining a sample size-based complementarity score by:

$${s}^{l} = {N}_{f}^{l} / {M}_{f} and {M}_{f} = max {N}_{f}^{1} , {N}_{f}^{2} , … , {N}_{f}^{n}$$

where

$${N}_{f}^{1} … {N}_{f}^{n}$$

are sample size of each client. s^{l} is the sample size score of client l.

In some embodiments, the method comprises determining a weighted average of the complementarity score by:

$${a}^{k ℓ} ∝ α ( \begin{matrix}No . of f - observable \\ samples at ℓ\end{matrix} ) + ( 1 - α ) ( \begin{matrix}complementarity b / w \\ {ξ}_{f}^{k} and {ξ}_{f}^{ℓ}\end{matrix} )$$

where [symbol] is the weighted average of the score, α∈[0,1] denotes the weight assigned to the sample size-based score, which controls the relative importance/influence of sample size versus complementarity.

In some embodiments, the method comprises determining a normalized weighted average of the complementarity score by:

$${w}^{kl} = {( {a}^{kl} )}^{β} / {\sum }_{j \neq k} {( {a}^{kj} )}^{β}$$

where w^{kl} is normalized weighted averaging of the complementarity score, a^{kl} is weighted averaging score, β is scale for normalization.

In some embodiments, the method comprises determining the individualized federated averaging data imputation model by:

$$Cafe - Av g ( k , f ) = γ \cdot {θ}_{f}^{k} + ( 1 - γ ) {\sum }_{ℓ \neq k} {w}^{k ℓ} \cdot {θ}_{f}^{ℓ}$$

where

$${θ}_{f}^{k}$$

denotes the parameters of the imputation model for feature f of client k, [symbol] denotes the weighted average of the complementarity score, and γ is the hyper parameter to control the relative influence of the local model and the weighted averaged global model.

In another aspect, this disclosure provides a system for complementarity-adjusted federated averaging imputation. In some embodiments, the system comprises one or more processors configured to implement the method as described herein.

### Examples of Complementarity-Adjusted Federated Averaging Imputation

This disclosure demonstrates an example of federated imputation of missing values, particularly in complex scenarios. It is critical to ensure that the resulting FL model is as accurate as possible. Missing data is typically characterized as either Missing Completely at Random (MCAR), Missing at Random (MAR) or Missing Not at Random (MNAR), each of which significantly increases in complexity. While initial work has considered the MCAR setting, n clients with heterogeneous complex mechanisms (MAR or MNAR) was considered in this example, that is, the setting where 1) n clients (i.e., owners of data silos) have independent and identically distributed (iid) data samples (X^{k} owned by client k) possibly with missing values, and, 2) the missing values generating mechanism, M^{k} (a standard and convenient way to model missing values) is different as well as being dependent either on the observable data (MAR) or even on data that is missing (MNAR). These settings, and in general, the MNAR setting is the most challenging to solve, where imputation methods perform poorly, even in the centralized setting (where all the data is available at one site). Yet this occurs in many real-world scenarios, and there is one crucial difference, in that the data from each site need not be guessed and can be differentiated. This fact, if utilized appropriately, as will be seen later, can be used to improve the imputation, and provide better results than even centralized imputation.

Heterogeneity in missing data is particularly problematic due to several factors, both individual and organizational. On the individual level, privacy concerns, the level of trust and acceptability that individuals perceive at an institution, their socioeconomic status, race, and gender are correlated with missing data. For example, high privacy concerns, lower trust, inability to afford a test or timely doctor's checkups, or concerns due to one's identity (racial or gender) can lead to heterogeneous missing data. Furthermore, in many healthcare scenarios, e.g., COVID-19 data, the demographic data, e.g., race, is missing, which can make the missing values for the other features MNAR and heterogeneous. On the organizational level, the differences in missingness originate from the differences in administrative policies and routines or bad practices regarding data collection and documentation. For example, some healthcare providers only record the positive values for symptoms and ignore the negative values, and some physicians are less likely to order some tests for certain individuals. This diversity in missing data mechanisms, shaped by both patient and institutional factors, can exhibit a variety of complementary characteristics in real-world settings.

For instance, two hospitals aim to construct a predictive model for diabetes management through federated learning, using their local EHRs. Hospital #1 (e.g., based on its data documentation practices) predominantly records only aberrant diagnostic (e.g., glucose and insulin levels) values from doctor's notes, resulting in normal values absent from the database. Hospital #2 faces challenges in data completeness due to its lower perceived patient trust (e.g., due to low quality care and concern for their identity), leading to a scenario where patients with abnormal glucose and insulin levels are unwilling to disclose their past diagnostics outcomes. In this case, the underlying mechanisms generating missing values are heterogeneous with a certain degree of complementarity because the missing values are dependent upon different characteristics, and they are MNAR because the characteristics are not observable in the data.

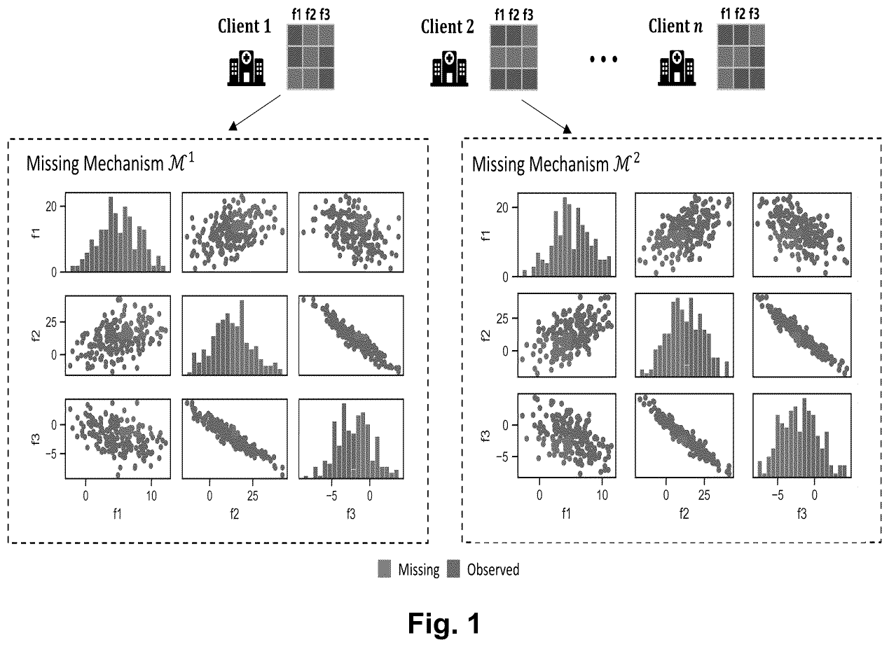

What if the data that is missing from Hospital #1 can be complemented by the observable data from Hospital #2 (and vice versa)?Consider the illustrative data example depicted in FIG. 1. In the figure, the pairwise plots of data for Client 1 and Client 2 are shown, where the data for Client 1 is missing from different parts of the features' distributions compared to that of Client 2. In this setting, one would surmise that client 1 and client 2 can perform some type of collaborative analysis, e.g., federated imputation, and help each other improve their data quality.

A novel method is described herein to solve this problem. The method leverages the information that missing values encode in each local dataset, i.e., the degree of mechanism heterogeneity. Namely, it models and learns an approximation of the missing mechanism for each client (for each feature) locally, and then measures their pairwise complementarity, i.e., the degree of heterogeneity of the mechanisms. The clients' pairwise complementarity, along with some additional information, is used to compute complementarity-adjusted federated (Cafe) averaging of the local imputation models. Also, while privacy is not the focus, since only model parameters of a missing mechanism prediction model are transferred from clients to the server, this significantly limits information disclosure during imputation. Thus, the disclosed method has the following features:
(1) Initiates the study of how to leverage heterogeneity in missing data across data silos to improve data processing and quality control, in particular, missing data imputation.
(2) Proposes the notion of a missing mechanism complementarity to measure the heterogeneity in the missing data of two different datasets as well as an efficient method to compute it (which is based on Imputation via Chained Equations (ICE) modeling).
(3) Develops a new method of complementarity-adjusted federated (Cafe) averaging, which is applied to learn imputation models. Importantly, this is the first imputation method that can naturally and gracefully handle the case of MNAR missingness. Using Cafe, Cafe-averaging based federated ICE imputation was developed and implemented, referred to in the rest of the paper as Cafe ICE.
(4) Conducts an extensive evaluation of Cafe ICE over a range of medical datasets, data distribution settings, and non-MCAR missing mechanisms over a variety of performance metrics. The results show that the method outperforms local imputation, simple averaging based Federated ICE, other state-of-the-art imputation methods, and ICE imputation in the centralized setting. Note that the fact that the approach outperforms centralized imputation is quite counter-intuitive and noteworthy, which will be discussed in more detail later.

### Preliminaries

First, the key notations, definitions, and the background were provided to place the work in context

Data, Missingness, and Clients:

$${X}^{*} = {\prod }_{f ∈ [ d ]} {X}_{f}^{*}$$

denotes the data universe of d features possibly with missing values, i.e., the values of one or more features may be missing in a data sample from X*; here X*=X_{f}∪{NA} where NA denotes that the value is missing and X_{f} is the set of possible values of feature f([d]={1, 2, . . . , d}). X=Π_{f∈[d]}X_{f} was used to denote the data universe without missing values. Only numeric features were considered in this work, referred to with labels 1, 2, . . . , d, though the work is extensible to categorical data.

n parties, referred to as clients, were considered, where each client k=1, . . . , n receives (or has) data X^{k} of N^{k} samples from X*, that is, one or more samples in X^{k} have NA as the value for one or more features.

Through the work, when k is not quantified, it refers to an arbitrarily chosen client unless mentioned otherwise. Now, for the data X^{k},

$${X}_{{f}_{i}}^{k}$$

denotes the values of feature f for the i-th sample in X^{k}, while

$${X}_{f}^{k}$$

denotes the values of f for all the samples in X^{k}. And,

$${X}_{- f}^{k}$$

denotes the data for all the features but f. For simplifying the exposition the convention that the first subscript for the data refers to the feature was used.

R^{k} was used to denote the missing indicators of the data X^{k}, that is,

$${R}_{{f}_{i}}^{k} = 1 if {X}_{{f}_{i}}^{k} = NA and {R}_{{f}_{i}}^{k} = 0$$

otherwise. A feature f is incomplete in X^{k} if one or more samples in X^{k} are missing values for f; similarly, f is incomplete in (X¹, . . . , Xⁿ^{ₙ}) if f is incomplete for at least one client.

A sample in X^{k} is f-unobservable if the value of the feature f is missing (i.e., is NA) in the sample; otherwise, the sample is called f-observable.

Missing Mechanisms. The clients data is from X* although the original data comes from X (i.e., without any missing values). The standard approach of missing mechanism was used to describe this transformation, i.e., the data without-missing values to with-missing values. A missing mechanism M_{f} for a feature f takes the data from X and outputs data in X*, that is, M_{f} (which can be probabilistic) generates missing values by replacing certain values of f by NA's.

Missing mechanisms are categorized into two types based on how the generated missing values are related to the data. These categories are as follows:
a) Missing Completely At Random (MCAR): A missing mechanism is MCAR if the distribution of missing values in the data is independent of the data distribution.
b) Non-MCAR: A missing mechanism is non-MCAR if the distribution of missing values depends on the data distribution. There are, however, two types of non-MCAR mechanisms: 1) when missing data distribution depends on the observable data distribution (i.e., the feature that the client observes or collects), the mechanism is missing at random (MAR); 2) when missing data distribution depends on the unobservable data distribution (i.e., the feature that the client does not observe or collect), the mechanism is missing not at random (MNAR).

In this example, non-MCAR mechanisms were considered, i.e., assuming that the missing values in feature f in client k's data are generated by a non-MCAR mechanism M^{k}. The non-MCAR settings—in particular, MNAR settings, also referred to as non-ignorable missingness—are challenging to tackle as opposed to MCAR settings.

### Imputation Via ICE in the Centralized Setting

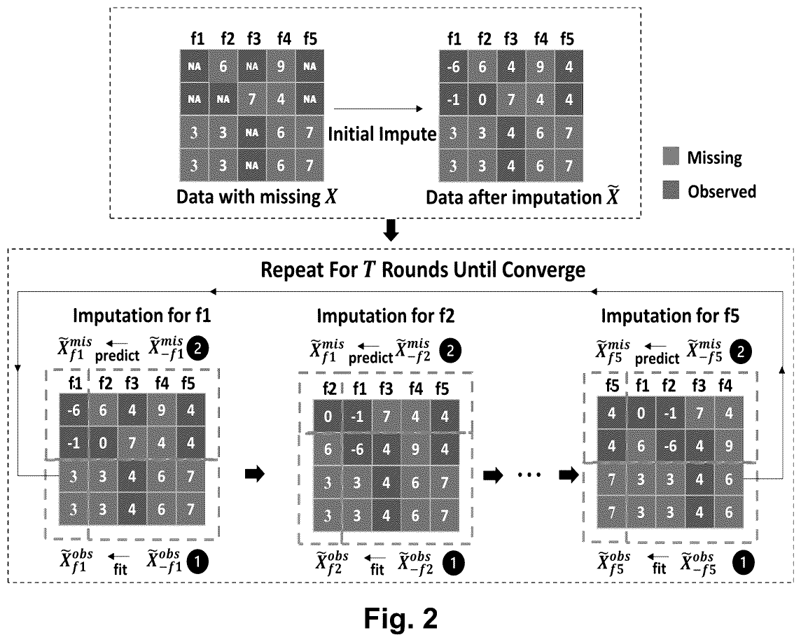

In data analysis and machine learning, complete datasets are crucial. A common method to address missing values is imputation. The MICE/ICE (Imputation by Chained Equations) methods (F. Pedregosa, et al. Journal of Machine Learning Research, vol. 12, pp. 2825-2830, 2011.) are popular for their effectiveness, simplicity, and efficiency. ICE employs feature-specific imputation models, that are built based on inter-feature correlations, to impute missing values. It then leverages iterative refinement of missing value estimates to capture the joint distribution of missing data across multiple features, thereby ensuring accurate imputations under complex missing data scenarios. ICE typically uses linear regression to learn imputation models, which is both effective and efficient, making it a preferred choice for handling missing data, though it can be modified to use neural networks and random forests as well. Here, the following ICE approach (simplified from MICE) from Chang et al. (C. Chang, et al. Nature communications, vol. 11, no. 1, p. 5467, 2020) in the centralized setting, where all the data is available at one site. FIG. 2 illustrates the details of the ICE approach.

Initialization: The missing values are initially filled in with simple imputations, like the mean or median.

Iterative Imputation Process: Each iteration consists of imputing each incomplete feature fin a sequential manner.
a) Learning imputation model for f: The algorithm treats f as the target and the remaining features as predictors. A linear regression model is then fitted on the f-observable samples of the target feature.
b) Updating imputations for f: The missing values in f are then imputed (or updated) using the newly fitted model.
c) Cycling through incomplete features: (a) and (b) are repeated for each incomplete feature using the most recently imputed data for fitting the model in part (a).

Convergence: Once the process converges, meaning that subsequent imputations do not significantly change, the last dataset, with all missing values imputed, is the final imputed dataset.

Federated ICE. Federated learning (FL) enables building models over distributed data. To create the federated version of ICE, the parts (a) and (b) of the iterative process (in the centralized ICE, described above) are done differently. Here, for each feature f each client learns the imputation models on its data, and sends its model to a designated party, called the aggregator. The aggregator computes a global model by taking a weighted average of all the received models, and sends the global model back to the clients. Each of the clients uses the received global model and uses it to impute the feature f to prepare for the next incomplete feature or the round.

### Problem Setting and Proposed Approach

This section describes the problem setup as well as how different data-owning clients can use federated learning and leverage heterogeneity of their missing mechanisms to build better imputation models to boost the quality of their missing data imputation. This section first outlines the high-level approach, namely complementarity-adjusted federated (Cafe) averaging, discusses its appropriateness, and then discusses the details.

### A. Problem Setup

The process considers n clients, each of which has iid samples from X*, the same data universe with missing values. Thus, the data, X^{k}, of any client k=1, . . . , n, may have one or more features missing in multiple samples, i.e., incomplete features. The process particularly considers the setting, where the mechanisms for at least one incomplete feature, say f are non-MCAR and heterogeneous across clients. Namely, for instance, consider the mechanisms

$${M}_{f}^{k} and {M}_{f}^{l}$$

(for k≠ [symbol] ) that result in different (i.e., non-iid) distributions of f-observable samples. Furthermore, the differences in these distributions are complementary, i.e., observable data at one client can complement the missing data in that of the other. It was aimed to develop a federated learning imputation method that can leverage the complementarity in missing mechanism to improve data imputation both locally and globally. It is sufficient to use the distribution of the data, rather than the raw data itself, to estimate complementarity.

### B. Vanilla Federated ICE and its Limitations

This section describes a basic federated imputation method and discusses the limitations of the existing approaches in dealing with heterogeneous non-MCAR missing mechanisms. Let F be the set of incomplete features across X¹, . . . , Xⁿ To leverage the data federation, the clients collaborate in building the ICE imputation model over the federated data as follows. In each round t=1, . . . , T:
1) Each client k updates its imputation model for each f∈F: Client k starts with the imputation models from the last round (one for each f∈F), and learns the imputation models

$$( {θ}_{f}^{k}$$

for every f∈F) for the current round using its local data (X^{k}). The client k then sends the updated imputation models to the aggregator.
2) The aggregator performs federated averaging: The aggregator receives the imputation models

$$( {θ}_{f}^{1} , … , {θ}_{f}^{n}$$

for each f∈F) from all the clients. It then aggregates the models, e.g., by taking a uniform or weighted average, and sends the aggregated model back to the clients.

For each feature, all clients share the same global model in this approach. Federated averaging, is the most crucial step. Many innovative solutions have been constructed by considering different meaningful weighting schemes. In vanilla federated averaging, all the local models are weighted proportionally to their training samples (TS)-size. However, simply using sample sizes is insufficient to completely capture the underlying mechanism heterogeneity and cannot result in the optimal model being selected.

A novel weighting scheme, Cafe averaging, was developed, in which the weights are not only proportional to TS-sizes, but in addition, the scheme accounts for the heterogeneity of the missing mechanism and leverages it to adjust weights. This helps to mitigate the issues of non-iid training sample space, which is induced by heterogeneity.

### C. Complementarity-Adjusted Federated (Cafe) Averaging

Despite the fact that the data at each client is iid, the set of f-observable samples across the clients can be non-iid when the missing mechanisms are heterogeneous across clients. For instance, consider that the clients' missing mechanisms are non-MCAR and heterogeneous; this results in f-observable samples across clients to vary in their distribution and numbers (recall that an f-observable sample is a sample in which the feature f is observable). A specific example of this can be observed in FIG. 1, where the observable data at Clients 1 and 2 are clearly non-iid due to the missingness mechanism.

Since the local imputation models (in ICE) are learned over the f-observable samples, the training data (for each f∈F) becomes non-iid across clients. In such a setting, the federated learning solutions that learn one global model using federated averaging perform extremely poorly for non-iid data distribution of each client. This, in particular, applies to federated imputation, where both the f-observable samples and the f-unobservable samples are non-iid due to the heterogeneous missingness mechanisms. In such a case, if one global imputation model is used to impute clients' non-iid f-unobservable samples, it is likely to result in poor data quality. Therefore, personalization can be used, which is one of the common techniques for handling non-iid situations in federated learning, though since the data to be imputed at any site is unobserved at that site, which creates a significant challenge for designing a personalized imputation model.

Specifically, if the distribution of f-observable samples at a client k complements the distribution of f-unobservable samples at a client [symbol] , the question is whether this complementarity can be leveraged to improve the imputation models in federated learning.

Accordingly, a method was proposed to estimate the complementarity and used to build personalized (i.e., client-specific) imputation models, which are optimized for the local missing data distribution (i.e., f-unobservable samples) for each client. In this way, the problems caused by one global model and the non-iid f-observable distributions can be addressed.

To achieve this, a model,

$${ξ}_{f}^{k} ,$$

was learned to approximate the missing mechanism

$$( {M}_{f}^{k} )$$

for each incomplete feature f at each client k. Then, for any pair of clients k and [symbol] , the dissimilarity between the two models, i.e.,

$${ξ}_{f}^{k} , and {ξ}_{f}^{l} ,$$

was measured to assess how complementary are the f-observable data distributions across the two clients. Since this complementarity is induced by missing mechanisms, referred to as missing mechanism complementarity or simply complementarity.

In addition to complementarity, the size of training data can also influence imputation model fitting. Insufficient training samples may result in suboptimal imputation models. Therefore, within a group of complementary clients, those with larger training data should have greater influence in the personalized aggregation. To achieve this, both complementarity and training sample size considerations were incorporated into the personalized model aggregation through a weighted integration approach.

Specifically, to adjust the weights for complementarity and training sample size (for an incomplete f), weights, [symbol] for each pair of client k and [symbol] (k≠ [symbol] ), were computed as follows: for each client k, its own model

$$( {θ}_{f}^{k} )$$

gets the weight γ∈[0, 1], while every other client's model,

$${θ}_{f}^{l} ,$$

gets the weight (1−γ) [symbol] ; here [symbol] is the complementarity and sample size-adjusted weight, and it is proportional to a weighted average of complementarity scores of the missing mechanism models (and

$${ξ}_{f}^{k} )$$

and the number of f-observable samples. Namely, for

$$α ∈ [ \begin{matrix}0 , & 1\end{matrix} ] , ∝ α ( \begin{matrix}No . of f - observable \\ samples at\end{matrix} ) + ( 1 - α ) ( \begin{matrix}complementarity b / w \\ {ξ}_{f}^{k} and\end{matrix} )$$

Thus, cafe average for client k is given as:

$$Cafe - Avg ( k , f ) = γ \cdot {θ}_{f}^{k} + ( 1 - γ ) \cdot$$

The parameter α controls the relative importance/influence of sample size versus complementarity. The parameters, γ and α, can be assigned by domain experts or tuned using hyper-parameter tuning methods. If the clients prefer, they can choose their own γ's (i.e., γₖ for client k); this gives a way to control how much each client wants to weigh its own model towards its updated model. In this work, however, the study was limited to having the same fixed γ for all.

### D. Cafe ICE

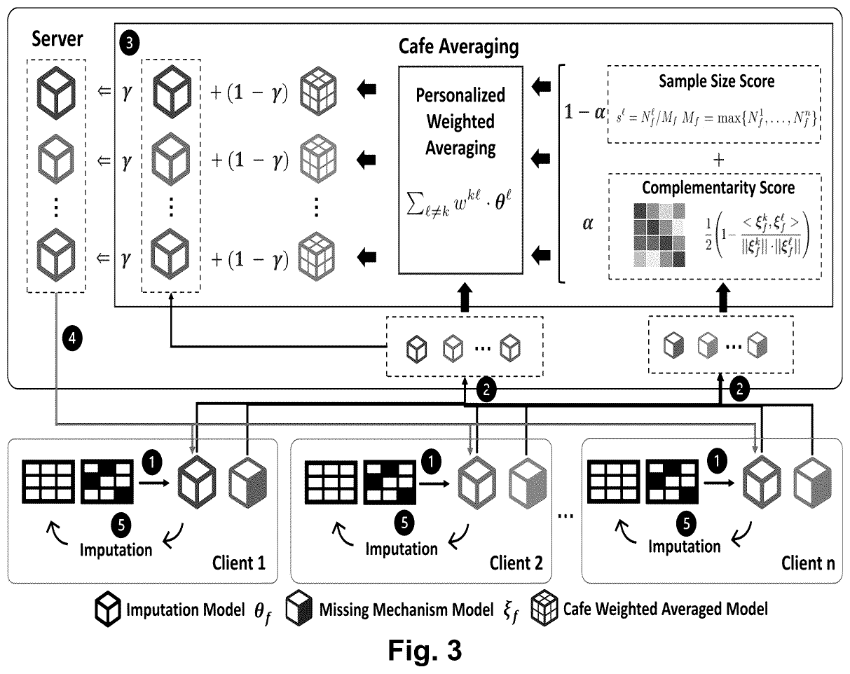

This section discusses how Cafe averaging was used to develop Cafe ICE, a federated learning based imputation method that uses ICE. Cafe ICE is effective for the setting, where data distributed across parties is iid but missing mechanisms are non-MCAR and heterogeneous such that some parties observable data distributions are complementary to the missing data distributions of other clients. Algorithm 1 outlines the key steps to implement Cafe ICE, and Algorithm 2 outlines how to compute the Cafe average. FIG. 3 pictorially depicts the key steps taken by Cafe-averaging at each iteration.

Algorithm 1: Complementarity Adjusted Federated (Cafe) ICE

| | |
|---|---|
| 1. | Input: X¹, X², ..., Xⁿ (data with misses, X^{k} at client k) |
| 2. | Output: \tilde{X}¹, \tilde{X}²,, ..., \tilde{X}ⁿ (imputed data) |
| | // Initial Setup and Imputation |
| 3. | [symbol] ← Incomplete-Features(X¹, ..., X^{k}) |
| 4. | for each client k = 1, ..., n, do |
| 5. | R^{k} ← Missing-Indicator(X^{k}) |
| 6. | (\tilde{X}¹, \tilde{X}²,, ..., \tilde{X}ⁿ) ← Naive-Fed-Impute(X¹, ..., Xⁿ) |
| | // Iterative Imputation |
| 7. | for each round t = 1, ..., T do |
| 8. | for each feature f ∈ [symbol] , do |
| 9. | for each client k = 1, ..., n, do |
| | // Partition X̅^{k} according to the missing indicator of f such |
| | that A^{k} corresponds to |
| | the observable part |
| 10. | A^{k}, B^{k} ← Partition(\tilde{X}^{k}, R^{k}_{f}) |
| | // Learn the local imputation model (θ^{k}_{f}) |
| 11. | θ^{k}f ← Linear-Reg.fit(A^{k}_{f}, A^{k}_{-f}) |
| | // Learn the local missing mechanism model (ξ^{k}_f) |
| 12. | ξ^{k}_{f} ← Logit-Reg.fit(R^{k}_{f}, \tilde{X}^{k}) |
| | // Server Aggregator: compute the client-specific federated |
| | average of the local |
| | models for f |
| 13. | Set Θ_{f} = {θ¹_{f}, ..., θⁿ} and Ξ_{f} = {ξ¹_{f}, ..., ξⁿ_{f} } |
| 14. | (\tilde{θ}¹_{f}, ..., \tilde{θ}ⁿ_{f}) ← Cafe-Avg(Θ_{f}, Ξ_{f}) // Algorithm 2 |
| | // Impute the misses in f with the updated model |
| 15. | for each client k = 1, ..., n, do |
| 16. | B̅^{k}_{f}← Linear-Reg.predict(\tilde{θ}^{k}_{f}, B^{k}_{-f}) |
| 17. | X̅^{k} = Concatenate(A^{k}, B^{k}) |

Cafe ICE (Algorithm 1) begins with each client k having its data X^{k} (possibly with missing values). In the setup phase, firstly, the clients compute the set of incomplete features, F (this can be done by each client sending its incomplete features to the aggregator). Secondly, each client k computes the missing indicators R^{k} of its data. Recall that

$${R}_{{f}_{i}}^{k} = 1$$

if the feature f is missing in the i-th sample in X^{k} and

$${R}_{{f}_{i}}^{k} = 0$$

otherwise. Note that, for simplifying the presentation, the first subscript refers to the feature.

The last step in the setup phase is the naive federated imputation. Namely, for each incomplete f∈F, they use the federated average to compute the global mean of f. This can be done as follows. 1) Each client k computes the mean,

$${μ}_{f}^{k}$$

using X^{k}; then it sends the

$${μ}_{f}^{k} and {N}_{f}^{k}$$

to the aggregator (where

$${N}_{f}^{k}$$

is the number of f-observable samples in X^{k}). 2) The aggregator computes

$${N}_{f} = {\sum }_{k = 1}^{n} {N}_{f}^{k}$$

and sends

$${μ}_{f} = {\sum }_{k = 1}^{n} {μ}_{f}^{k} {N}_{f}^{k} / {N}_{f}$$

to all the clients. 3) For each incomplete feature f in X*, the client k uses μ_{f} as the imputed value for all the missing values of f, This results in the first imputation of the data, denoted as \tilde{X}ₖ. It is noted that clients could instead use the local mean

$$( i . e . , {μ}_{f}^{k} )$$

as the imputed value, the potential implications of which are discussed later. This strategy is useful to limit information disclosure in the case of categorical features where the clients can use local mode as the initial imputation.

After the setup, follows the iterative imputation phase, wherein the clients iteratively improve their imputation models. Below, the algorithmic details of this phase for an arbitrary round t and an incomplete feature f∈F were described. Each client k takes the most recently imputed data (either in line 6 or lines 17-18), and partitions it into A^{k} and B^{k}, which respectively correspond to the f-observable samples and f-unobservable samples from X^{k}, The client k builds a local imputation model,

$${θ}_{f}^{k} , ,$$

for f by linear regression on the data where the dependent variable

$$Y = {A}_{f}^{k}$$

and the independent variable(s)

$$X = {A}_{- f}^{k} .$$

Next, it builds the model,

$${ξ}_{f}^{k} ,$$

for its missing mechanism using logistic regression for the dependent variable

$$Y = {R}_{f}^{k}$$

based on the independent variables X=\tilde{X}ₖ. It then sends

$${θ}_{f}^{k} and {ξ}_{f}^{k} ,$$

to the aggregator. The method of approximating the missing mechanisms using logistic regression is very appropriate in the context of ICE imputation, and the empirical evaluation shows that missing mechanism complementarity can indeed be captured by the model and serves as a good proxy for mechanism heterogeneity.

After the aggregator receives the models from all the clients, it uses Algorithm 2 to compute the updated models ( [symbol] for client k) using Cafe averaging, and sends the updated models to the clients. Once each client k receives its updated model [symbol] , the updated model is used to compute new imputation values for its missing values of f using the data

$${B}_{f}^{k}$$

The new imputed values are stored in B^{k} Next, the client concatenates A^{k} and B^{k} (now with updated imputed values) and uses it as \tilde{X}ₖ which will be used in going forward (i.e., for the next feature or the next round), or as the final imputation if the iteration procedure is set to terminate (either due to convergence or due to carrying out a sufficient number of rounds.)

Algorithm 2: Complementarity Adjusted
Federated (Cafe) Averaging

| | |
|---|---|
| 1. | Parameters: Hyper-parameters α, β, γ |
| 2. | Input: θ¹, ..., θⁿ (clients' imputation models) and ξ¹, ..., ξⁿ (clients' |
| | miss mechanism |
| | models) for feature f |
| 3. | Output: \tilde{θ}¹, ..., \tilde{θ}ⁿ (clients' updated imputation models) |
| 4. | M_{f} = max {N_{f}¹, ..., N_{f}ⁿ } // Nf^{k} = # of f-observable samples in X^{k} |
| 5. | for each k = 1, ..., n do |
| 6. | for each [symbol] ≠ k do |
| 7. | // Compute pair-wise complementarity scores (CS) |
| 8. | [symbol] = Complementarity-Score(ξ^{k}, [symbol] ) |
| 9. | [symbol] = [symbol] / M_{f} // sample-size based score (SS) |
| | // Compute weighted average of CS and SS |
| | [symbol] = [symbol] + (1 − α) [symbol] |
| 10. | for each [symbol] ≠ k do |
| 11. | // Compute normalized weighted avg. of CS and SS |
| 12. | [symbol] = ( [symbol] )^{β} / Σ_{{j ≠ k}} (a^{kj}) ^{β} |
| 13. | // Compute client-specific weighted avg. of local models |
| 14. | \tilde{θ}^{k} = γθ^{k} + (1 − γ) [symbol] |

Algorithm 2 computes Cafe averaging based personalized updated imputation models for each client. For each client k, Cafe averaging weighs the models of the other clients [symbol] ≠k, proportional to their f-observable sample sizes

$$( i . e . , {N}_{f}^{k} )$$

and the complementarity of their missing mechanism's models with respect to the missing mechanism model for k. Thus, for each client k, the complementarity scores and sample size scores corresponding to all the other clients were computed. For complementarity scores (given by Eq. 1), the cosine similarity between the missing mechanism models,

$${ξ}_{f}^{k} and {ξ}_{f}^{l}$$

(both of which are vectors in R^{d+1}) was used.

$$Complementarity - Score = \frac{1}{2} ( 1 - \frac{< {ξ}_{f}^{k} , {ξ}_{f}^{ℓ} >}{‖ {ξ}_{f}^{k} ‖ \cdot ‖ {ξ}_{f}^{ℓ} ‖} )$$

The complementarity scores are commutative, ranging between 0 and 1, where 0 means the models are identical, namely, they have no complementarity; and 1 means there is significant complementarity between the models. In the case, when one or both of the clients have no value missing in their feature f, the complementarity score is defined to be 1. This is because all the clients have iid samples (in the setting), and each one has significant information to contribute when f is fully observable in their data.

After computing the complementarity score of the client [symbol] for the client k, sample size based score of the client [symbol] was computed, which is based on the number of f-observable samples in X^{l}. Here, max as opposed to sum was use, because the complementarity and sample size scores should be comparable when their average was taken to compute the combined-score; allowing control of their influence only using the parameter α.

Once for a client k, all the combined-scores for all the clients, [symbol] ≠k, are computed, they are normalized (using β to control the normalized distribution), and the normalized weights are used to compute the weighted average of all the models for the client k. γ controls the influence of one's own model in the updated model. This completes the discussion and description of the disclosed approach. In the next section, Cafe ICE was evaluated over a range of mechanism settings, scenarios, and data set.

### Empirical Evaluation and Results

In this section, Cafe ICE across diverse configurations was rigorously evaluated. Practical data federation scenarios, with clients owning iid datasets that have missing values (simulated using heterogeneous MNAR mechanisms), and a range of data distribution settings (sample sizes and mechanism choices) were considered. Then, imputation was performed in each setting using Cafe ICE and other baselines. The quality of imputation was evaluated using a range of metrics as well as downstream federated prediction. Finally, an analysis of the evaluation results was provided.

### A. Experimental Setup

Datasets: five large standard public datasets from the fields of healthcare and bioinformatics (Table I) were used. Codon: for codon usage frequencies classification from uci machine learning repository. Codrna: for non-coding RNA detection. MIMICIII: a dataset of EHRs (electronic health records) from ICUs, adapted for patient post-admission modality problems. Heart: for heart disease prediction based on indicators extracted from annual CDC surveys. Genetic: a dataset curated from ClinVar dataset for genetic variant conflicts prediction.

TABLE I
Dataset Summary. #Pos/#Neg represents the ratio
between the number of positive and negative samples,
indicating the degree of class imbalance of each dataset.

| Datasets | #Samples | #Features | #Classes | #Pos/#Neg |
|---|---|---|---|---|
| Codon | 13,008 | 26 | 10 | — |
| Codrna | 20,000 | 9 | 2 | 0.53 |
| MIMICIII | 20,000 | 51 | 2 | 0.37 |
| Heart | 20,000 | 25 | 2 | 0.09 |

Categorical features were replaced by their one-hot encoding, followed by Principal Component Analysis (PCA), thus resulting in only numeric features. The dataset sizes were capped to be at twenty thousand samples; if a dataset was larger, a uniform sample was obtained.

Baselines: Cafe ICE was compared with three ICE-based imputation baselines, as well as two other state-of-the-art imputation models: (1) Central, referring to the centralized case, where all clients' data is merged at one central place and imputed using ICE imputation. (2) Local imputation, where each client imputes its data using ICE locally (without any collaboration). (3) FedICE, federated ICE, which uses model weights proportional to clients' sample sizes in the federated averaging. (4) FedMIWAE, federated averaging version of MIWAE imputation. (5) FedGAIN, federated averaging version of GAIN imputation.

Evaluation Metrics: Imputation quality was measured using RMSE (root mean square error), Sliced-WS (sliced Wasserstein distance), and visualization of t-SNE (t-distributed Stochastic Neighbor Embedding) plots. Lower RMSE and Sliced-WS denote better imputation quality. The effects of imputation quality were further measured via downstream federated prediction using the imputed datasets, and the performance was reported using AUROC (area under the receiver operating characteristics) and F1-Scores (these metrics were used because of the class imbalance in the datasets, see Table I, though standard Accuracy and area under the precision-recall curve, AUPRC, which are not reported due to space limitations, were also checked.) For the downstream task, a global model (2-layer neural network) was learned using federated learning with FedAvg protocol. The performance is reported over iid sampled test sets.

Implementation Details: Cafe ICE was implemented by modifying the Iterative Imputer of the Sklearn library. Ridge and logistic regression were used, respectively for imputation and missing mechanism prediction models with 20 rounds. For Cafe ICE, hyper-parameters (α, β, γ) were tuned via grid search in parallel with: α from 0.5 to 1.0; β from 2 to 4; and γ from 0.05 to 0.3. Grid search requires 5-10× time than that of a single run depending on different datasets. This time can be reduced using advanced tuning methods, such as Bayesian optimization. Importantly, the optimal parameters given by the search are similar across all datasets and scenarios; therefore, in practice, using fixed parameters α=0.95, γ=0.05, β=4, or those set by domain experts, rather than tuning hyper-parameters is recommended. PyTorch 11.2 was used for federated prediction via FedAvg algorithm. Each client used a two-layer neural network with 32 to 64 hidden nodes (depending on dataset dimension) with the Adam optimizer and learning rate 0.001. Each experiment setup is repeated five times with new and independent randomness to ensure reliability, and the average results are reported.

### B. Missing Data Simulation & Federated Scenarios

MNAR mechanisms were simulated for they not only occur in real-world settings but are challenging to address. Two methods were used to simulate MNAR missing data.

The first one is a quantile-based method to design missing mechanisms as follows. Two classes of MNAR missing mechanisms, MNAR-Left and MNAR-Right, were considered. For a given feature, f, and a missing rate ρ, an MNAR-Left mechanism erases f's values (i.e., replaced by NA) that are in a percentile range [0, ρ]. On the other hand, MNAR-Right erases f's values that are in percentile range [1−ρ, 1]. This design allows for a range of mechanisms as well as complementarity relationships.

Using the above classes of missing mechanisms and missing rates, the four different levels of missing mechanism complementarity were considered. M₁=M(D₁, ρ₁) and M₂=M(D₂, ρ₂) were used to denote the missing mechanisms with missing rate ρ₁ and ρ₂ and directions D₁, D₂∈{R, L} (R for Right and L for Left).
Perfect Complementarity: M₁ and M₂ are in perfect complementarity if D₁≠D₂ and ρ₁=1−ρ₂, e.g., M(L, 0.3) and M(R, 0.7) are in perfect complementarity.
Imperfect Complementarity: M₁ and M₂ are in imperfect complementarity if D₁≠D₂ and ρ₁≠1−ρ₂.
One-sided Complementarity: M₁ and M₂ are in one-sided complementarity if D₁=D₂ and ρ₁≠ρ₂, e.g., M(L, 0.3) and M(L, 0.5).
No Complementarity: M₁ and M₂ have no complementarity if D₁=D₂ and ρ₁=ρ₂, i.e., they are identical.

Furthermore, a complex MNAR simulation method using logistic regression—referred to as Logit-based mechanism was considered. Here, for each feature, its missing values are generated by a logistic model with random weights, which takes the feature itself and the other 25% of highly correlated features of the dataset as inputs. To allow for missing mechanisms heterogeneity and complementarity, for each feature, the random weights for the logistic model are drawn from the region of a unit hypersphere confined to a conical section defined by a specific angular range (30 degrees) along the feature's axis. This constraint maintains the MNAR nature of the missing data mechanism while ensuring that missingness in one feature correlates with other features. Since this mechanism was used to create missing values in all the features, 1) the missingness is MNAR, 2) missingness of the features is correlated with multiple variables, and 3) the missingness is much more complex relative to the approach in Muzellec, et al. (B. Muzellec, et al. International Conference on Machine Learning. PMLR, 2020, pp. 7130-7140) which creates only one feature with MNAR missingness.

Federated Learning Scenarios Under Missing Data. Ten clients, each with an iid sample as its local data were considered. To simulate the heterogeneity of missing mechanisms among clients, the following scenarios, differing in the levels of complementarity and generalization, were considered. The M-set was used to denote the set of all missing mechanisms corresponding to different values of ρ's and direction.

Ideal scenario: For all features, half of the clients are M(L, 0.5) and the other half are M(R, 0.5), creating an ideal scenario of complementarity, where Cafe should perform very well. Perfect complementarity scenarios (S1): Pick a client uniformly at random, then for each of its features, pick a missing mechanism uniformly at random from M-set and assign the perfect complement of the mechanism for the same feature for all other clients. For example, if for a feature, f, M(L, 0.3) was picked for the selected client, then all others will have M(R, 0.7) for f Imperfect complementarity scenario (S2): Similar to S1, pick a client at random, then for each of its features, pick a mechanism at random from M-set for it, and for each of the other clients, pick at random a mechanism with imperfect complementarity. One-sided complementarity scenario (S3): It is similar to S2 except for the other clients, a mechanism with one-sided complementarity was selected at random. No complementarity scenario (S4): All clients have the same mechanism for all the features, i.e., either M(R, 0.5) or M(L, 0.5), resulting in absolutely no complementarity.

Complex mixture scenarios: Additionally, two complex scenarios consisting of a mixture of missing mechanisms, varying across features and clients with respect to complementarity and missingness correlation with other features, were considered. In Complex Scenario #1, for each client and each feature, the quantile-based mechanism is randomly picked from the M-set, resulting in the missing data being independent of the other features. Complex Scenario #2 follows the first scenario, except the M-set now consists of the Logit-based mechanism (described above), which is used to simulate missing values (correlated with multiple features) for different missing ratios.

Now, consider the missing rate, ρ: although ρ can take any value between 0 and 1, the missing rate was limited to be moderate, i.e., in between 0.3 and 0.7 because sufficient data (for learning) and sufficient missing rate (to analyze its effects) in all of the cases are desired. Under these limits, ρ=0.3, 0.4, 0.5, 0.6, 0.7, i.e., increments of 0.1, were considered. Now, M-set will consist of mechanisms corresponding to these missing rates for each direction. Using more granular ρ's was considered, and the results were found to be similar.

### C. Results

The evaluation of Cafe focuses on the following aspects and results in the following key observations:
1) Complementarity score verification: Cafe can effectively capture complementarity between missing mechanisms across clients under different scenarios.
2) Performance across complementarity levels: Under high complementarity levels, Cafe significantly outperforms the other baselines. Otherwise, it performs as well as others.
3) Effectiveness in complex scenarios: Cafe performs well in complex settings.
4) Impact of sample size distribution: Cafe is robust, i.e., its performance remains consistent under different client sample size distributions.
5) Scalability and efficiency: Cafe's performance is comparable to that of the baselines for different numbers of clients and sample sizes.

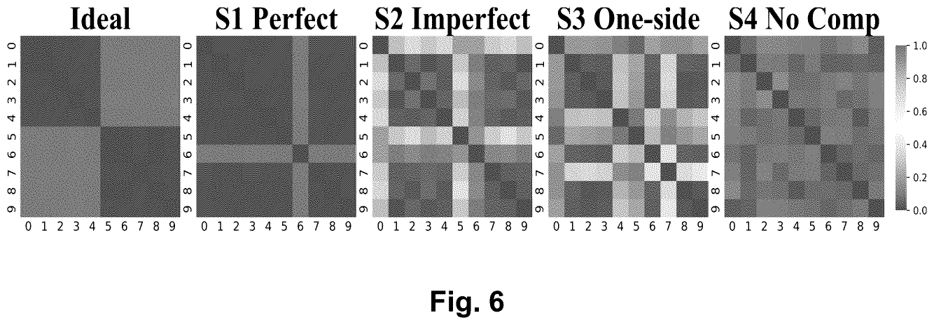

Complementarity scores evaluation. This section first shows the method to compute complementarity scores, which is used in Cafe ICE, can effectively capture the different levels of complementarity between clients' missing mechanisms. As illustrated in FIG. 6, the heatmap of complementarity scores reveals that the distinct patterns across different scenarios are captured correctly. In the Ideal and Perfect complementarity scenarios (S1), a clear distinction in complementarity scores is observed between clients, with extremely high scores (close to 1.0) indicating perfect complementarity and low scores (close to 0) within clients of the same mechanism. Conversely, no complementarity scenario (S4) shows uniformly low scores, reflecting the absence of complementarity. In the Imperfect (S2) and One-sided complementarity scenarios (S3), complementarity scores show variation, with some clients exhibiting relatively high but not near-perfect scores, indicative of some degree of complementarity. Overall, the scoring scheme accurately reflects the complementarity level of clients' missing mechanisms in each scenario.

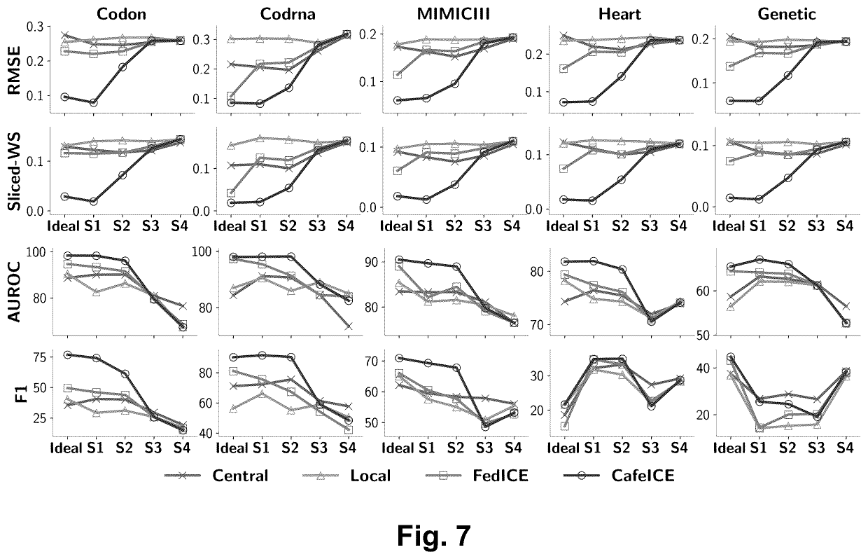

Evaluation across different levels of missing mechanism complementarity. In this section, a comprehensive evaluation of Cafe ICE was conducted under scenarios with various levels of client missing mechanism complementarity. FIG. 7 illustrates imputation quality and federated prediction results. This section provides three key observations. Firstly, there is a trend of decreasing imputation performance by Cafe ICE as the level of missing mechanism complementarity reduces, aligning with the earlier findings on complementarity score verification. Secondly, in scenarios with high to moderate complementarity (i.e., Ideal, S1, and S2), Cafe ICE significantly outperforms baselines in both imputation and federated prediction tasks. Thirdly, in scenarios with lower complementarity (i.e., S3 and S4), Cafe ICE maintains comparable imputation quality and federated prediction performance to the baselines. In practical scenarios, missing mechanisms are expected to be a mix of different levels of complementarity across features and clients. Therefore, Cafe ICE's comparable performance in low complementarity scenarios, and its superior performance in moderate to high complementarity scenarios underscores its effectiveness for practical applications. Overall, these observations support Cafe ICE as a more robust and adaptable solution compared to the state-of-the-art baselines.

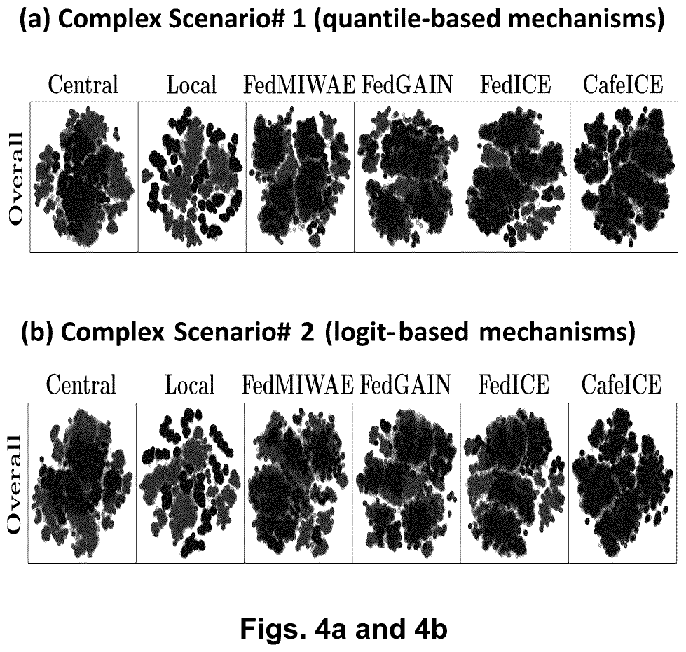

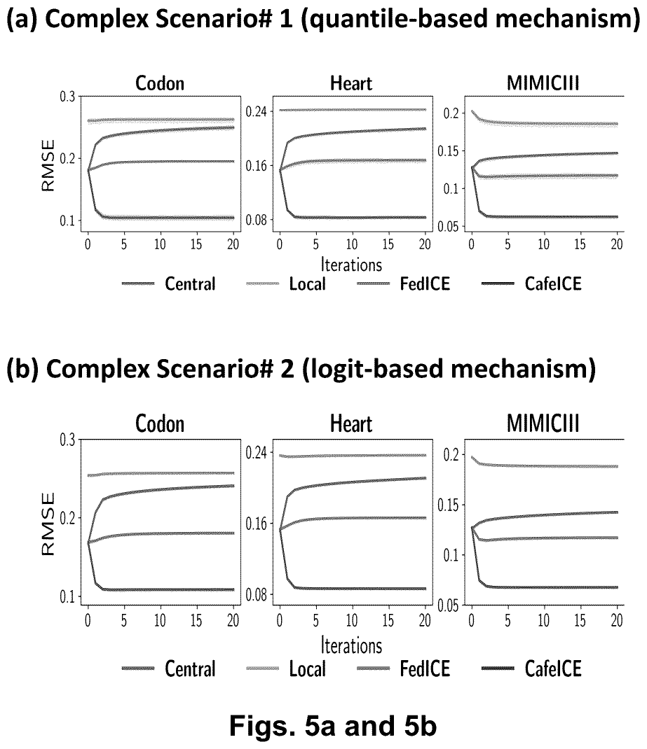

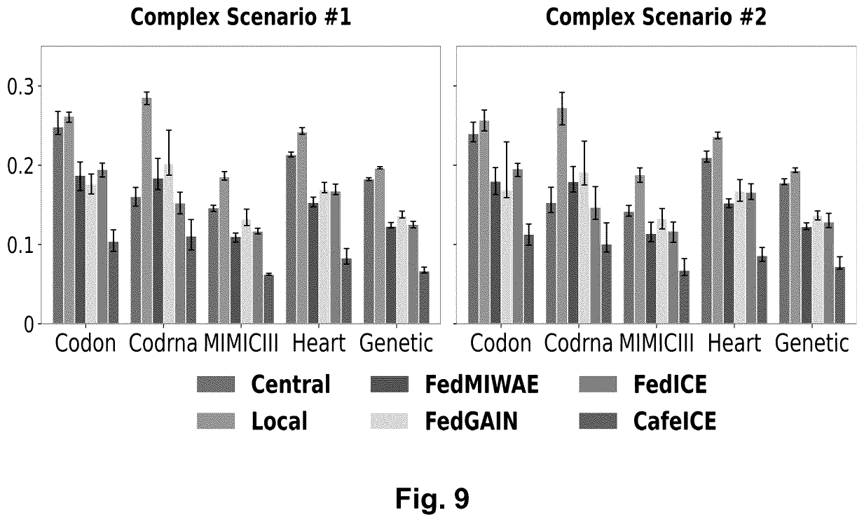

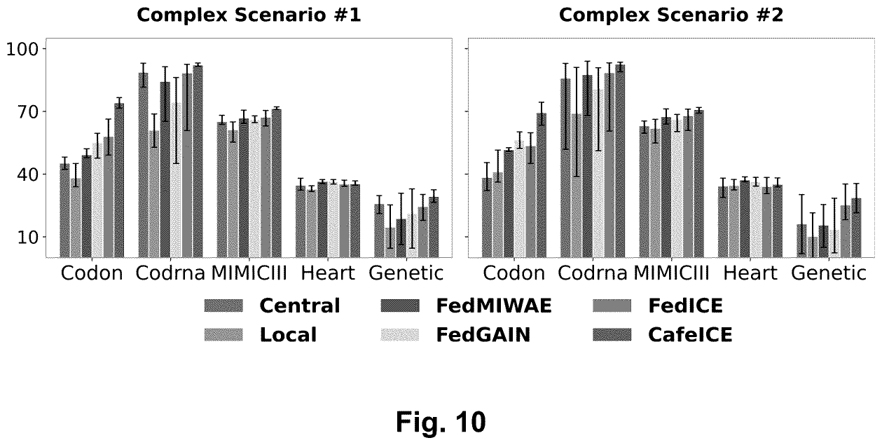

Evaluation in complex scenarios. Here, complex scenarios (#1 and #2 as discussed above) where missing mechanisms are a mix of varying levels of complementarity across features and clients (here, all clients have the same number of samples) were considered. The evaluation focuses on imputation quality (RMSE), convergence rate, and downstream task performance.
1) Imputation quality and convergence. The RMSE of imputation for Cafe ICE and the baselines are shown in FIG. 9. Across both complex scenarios, Cafe ICE has significantly lower error compared to not only ICE-based baselines but also VAE or GAN-based advanced imputation methods. t-SNE plots (FIG. 4) also show the same; that is, the data imputed by Cafe ICE closely aligns with the ground truth, unlike other methods, which exhibit noticeable deviations, underscoring Cafe's accurate recovery of missing values. Next, the error convergence was examined (FIG. 5), observing all methods converge within 5-10 iterations. Notably, Cafe ICE's error diminishes significantly upon convergence, in contrast, the baselines can even result in higher error. Upon convergence, the final imputation error of Cafe ICE is significantly lower than baselines. Individual clients' performance mirrors the general trend, as seen from the narrow error bands around the solid line depicted in FIG. 5.
2) Federated prediction. FIG. 10 shows that overall Cafe ICE outperforms the baselines, particularly, for Codon, Codrna, and MIMICIII. Cafe ICE performs significantly better on the Codon task, a multi-class classification task, which is more sensitive to missing data than other tasks. Even if the baselines (FedICE or computationally demanding FedGAIN and FedMIWAE) can approach Cafe ICE in some cases, they exhibit higher variation across multiple runs of the experimental (depicted by the black). Baselines' higher variation indicates their sensitivity to small distributional differences due to randomness (e.g., a different seed). Thus, these results indicate Cafe ICE's robustness and effectiveness in enhancing downstream federated prediction in practical settings.

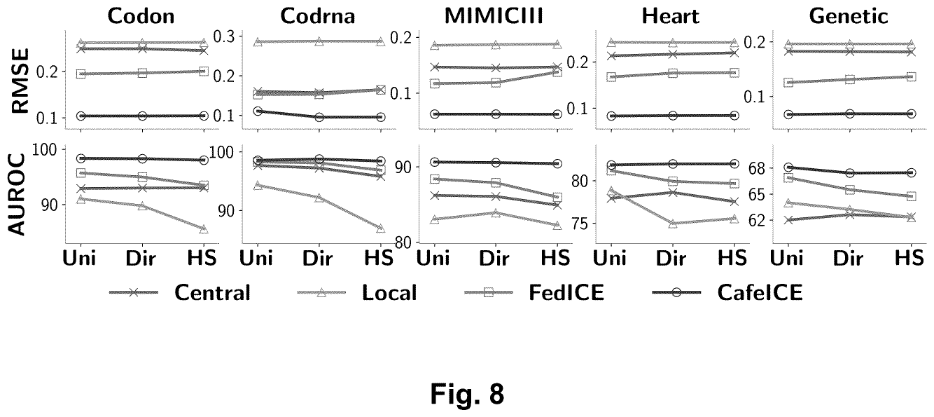

Effect of varying sample sizes across clients. Here, complex scenarios were considered for missing data simulation because it is not biased toward any particular method. First, the effect of sample sizes across clients was explored. Three strategies were used to select sample sizes for each of the clients, and then assign to each client the iid samples corresponding to its selected size. The following are the three strategies. Uni assigns equal sample sizes; Dir assigns sample sizes according to Dirichlet distribution (with parameter 0.1 for moderate heterogeneity); and HS (hub-spoke setting) assigns one client (hub) 50% of total data and the rest (peripherals) 5% each. The results, focusing on Sliced-WS and AUROC (with RMSE and F1 showing similar trends), are given in FIG. 8. The variation for Central and FedICE is potentially due to the changes in the global missing mechanism. Note that the global mechanism is the collection of the clients' heterogeneous mechanisms, and when clients' sample sizes differ, Central, which uses one imputation model for the whole data, is not able to account for how this difference influences its imputation model. Although FedICE takes the sample size into account, it is unable to capture the effect of heterogeneity or deal with the impact of sample size on it. Conversely, Cafe ICE consistently exhibits minimal variation and surpasses the baselines. Notably, Cafe ICE (compared to the baselines) shows improved performance when sample sizes differ across clients, indicating its effectiveness in realistic scenarios.

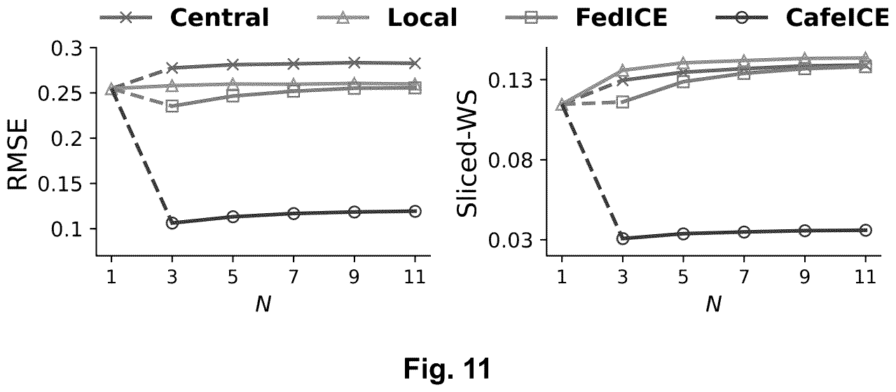

Effect of varying the number of clients. The impact of varying numbers of perfect complementarity clients on Cafe ICE's imputation performance was investigated. A scenario was simulated with one hub client as MNAR-Left (M(L, 0.5)) and an increasing number of clients exhibiting perfectly complementarity mechanisms (i.e., MNAR-Right as (M(R, 0.5)) from 2 to 10. As depicted in FIG. 11, the presence of complementarity clients significantly reduces imputation errors, and this effect remains stable with an increasing number of complementarity clients. This observation suggests that Cafe ICE's performance is robust in terms of the number of complementarity clients it has. Notably, a few clients with complementarity missingness can markedly enhance the effectiveness of imputation. Notably, Cafe ICE's performance remains stable as the data and network size grows.

Evaluation of running time. Finally, Cafe ICE's runtime was compared with baseline methods. This section reports the average running time for each dataset across all scenarios for four methods. As shown in Table II, given that Cafe ICE only requires fitting an additional linear model for mechanism prediction, its runtime for each dataset is comparable to that of FedICE and other baselines. Overall, Cafe ICE is quite efficient in practice.

TABLE II
Running Time (s). Average accumulated running time for
all clients and the server across all scenarios.

| Methods | Codrna | Codon | MIMICIII | Heart | Genetic |
|---|---|---|---|---|---|
| Central | 134.63 | 115.02 | 499.98 | 206.13 | 251.69 |
| Local | 120.79 | 160.88 | 654.9 | 271.64 | 330.55 |
| FedICE | 126.09 | 160.15 | 688.75 | 281.33 | 341.17 |
| Cafe ICE | 126.48 | 163.78 | 744.06 | 293.19 | 370.99 |

In this example, a novel complementarity adjusted federated Cafe ICE averaging approach for federated imputation that can be used to develop personalized imputation models for different clients was demonstrated. The approach is highly effective in the cases where the underlying missingness is heterogeneous and also performs as well in other scenarios with simpler (MCAR and MAR) missingness characteristics. One really counter-intuitive observation is that Cafe ICE can outperform centralized imputation when heterogeneous MNAR missingness occurs. This is because Cafe ICE is able to leverage the complementarity between the data and also knows a priori the data partitioning (due to the federated imputation.)

By adjusting specific hyperparameters, Cafe ICE can adapt to other scenarios, offering versatility across various data missingness patterns. For example, by setting γ, a client can decide how much it relies on other clients. If the client thinks the local missing mechanism is not complicated (say, MCAR), it can set γ to be high to rely more on its local model. α controls the contribution between sample size and complementary score. When α increases to 1, the aggregation weights are only determined by sample size, so it returns to a simple average-based algorithm. Searching for the best strategies for hyper-parameters can be done either by using domain knowledge or some reward-based algorithm (e.g., Reinforcement Learning), which can be an interesting future direction.

With respect to theoretical analysis, extensive analysis has been conducted on conventional FL that facilitates learning a single global model from homogeneous data across clients, under a strongly convex loss function, and several other assumptions, ensuring the convergence of the FedAVG algorithm. However, in scenarios characterized by complete heterogeneity, local models can diverge significantly, and thus, independently learned local models outperform the global model. These two extreme cases are special cases of Cafe ICE (with specific α, γ values), where the above guarantees would apply.

Although the work focuses on a single imputation based on ICE, it can be readily extended to multiple imputation based on MICE. One intuitive way is to replace the vanilla linear imputation model (such as Ridge Regression) with the Bayesian linear imputation model (such as Bayesian Ridge Regression). The final imputation values can be drawn from the posterior distribution modeled by Bayesian models, which makes multiple imputation possible. The selection of proper prior and optimization strategies for the Bayesian model for each client can also rely on a missing mechanism model.

### Federated Imputation of Missing Data Using Knowledge Transfer-Based Collaborative Estimation (KT-ICE)

Federated learning (FL) is a decentralized machine learning paradigm that enables collaborative model training across multiple clients while preserving data privacy and autonomy. In accordance with this principle, the present disclosure provides systems and methods for federated imputation of missing values in datasets distributed across a plurality of clients.

In some embodiments, a federated learning system is configured to address the challenge of missing data, particularly under a mixed missing data mechanism. Specifically, in a representative scenario, a majority of participating clients exhibit missing-not-at-random (MNAR) data patterns, while a minority of clients exhibit missing-completely-at-random (MCAR) patterns or possess complete datasets.

To address this challenge, a personalized federated learning framework, designated as Knowledge Transfer-based Imputation via Collaborative Estimation (KT-ICE), is disclosed. In this approach, the imputation of missing values on MNAR clients is facilitated through the transfer of knowledge that is constructed from clients exhibiting the MCAR mechanism or having complete data.

In KT-ICE, transferable knowledge is derived from MCAR-type clients and is subsequently employed to construct personalized imputation models for MNAR-type clients. The proposed method is theoretically supported to ensure that the transferred knowledge is both relevant and reliable under the federated setting.

In federated learning environments, data incompleteness is a prevalent issue across client datasets. Missing data not only compromises data integrity but also directly impacts the efficacy of subsequent model training and prediction. Traditional federated imputation methodologies predominantly operate under the assumptions of Missing Completely At Random (MCAR) or Missing At Random (MAR), employing statistical properties of observed data for imputation. However, real-world data missingness often exhibits more complex patterns and is not believed to be MCAR or MAR. Instead, it is often the case that missingness correlates with the unobserved information—a condition known as Missing Not At Random (MNAR). This complexity introduces systematic biases when conventional methods are applied to MNAR data, resulting in suboptimal imputation outcomes.

While the majority of clients exhibit complex Missing Not At Random (MNAR) characteristics, due to heterogeneous missingness arising from varied data collection practices, operational environments, and regulatory frameworks, a subset of clients may still maintain data with simpler missingness, such as Missing Completely At Random (MCAR), or even near-complete datasets with only minimal missing values. For example, some clients may adopt more rigorous data collection protocols and stricter regulatory guidelines, resulting in better quality of their datasets with simpler missingness. These clients with relatively simpler missingness can serve as valuable reference points for improving imputation in clients affected by MNAR. By strategically leveraging the reliable statistical properties derived from these reference clients, the imputation quality for MNAR-affected clients is significantly enhanced, thereby improving the overall performance of federated learning systems. Through this knowledge transfer approach, a critical gap in existing federated imputation methodologies, namely, the frequent oversight of diverse missingness mechanisms across distributed clients, is effectively addressed.

Based on this intuition, a knowledge transfer-based ICE (Imputation by Chained Equations) approach is proposed. In this method, information derived from clients exhibiting simpler missingness is leveraged to enhance the imputation quality for clients affected by missing-not-at-random (MNAR) conditions. As a result, data quality across the entire network is improved, and federated learning performance is bolstered.

The proposed method is structured in two primary stages. In the first stage, a set of regression models for each feature is collaboratively trained by clients with simpler missingness using federated learning techniques. These models are configured to capture inter-feature relationships. The parameters of the trained models are treated as global knowledge, which is subsequently transferred to clients experiencing more complex missingness (i.e., MNAR). In the second stage, the global inter-feature relationship information is incorporated by the MNAR clients into their local imputation processes. A novel strategy is introduced in which a linear combination is employed between the global imputation model (derived from the transferred global knowledge) and the local imputation model (learned from the local data). This combination is weighted by a missing propensity factor that is estimated based on the local missingness. This weighting is determined as the optimal approach for integrating the global knowledge-acquired from clients with simpler missingness-into the local imputation performed by MNAR clients.

The strategy is theoretically supported through analysis of the optimal imputed values under MNAR conditions. Preliminary empirical evaluations, conducted using eight public datasets and compared with several baseline methods, have demonstrated that the proposed approach improves imputation quality for MNAR clients and enhances overall federated learning performance.

This chapter is organized as follows. First, the problem of MNAR missingness in federated networks is formally defined. Next, the proposed methodology is described in detail. Finally, preliminary experimental results are presented, and a summary is provided to conclude the chapter.

### A. Data, Missingness, and Clients.

$${𝒳}^{*} {\prod }_{f ∈ [ d ]} {𝒳}_{f}^{*}$$

denotes the data universe of d features possibly with missing values, i.e., the values of one or more features may be missing in a data sample from [symbol] *; here

$${𝒳}_{f}^{*} = {𝒳}_{f} ⋃ \{ NA \}$$

where NA denotes that the value is missing and [symbol] _{f} is the set of possible values of feature f([d]={1, 2, . . . , d}).

[symbol] =Π_{f∈[d]} [symbol] _{f} is used to denote the data universe without missing values.

Note that only numeric features are considered in this work and refer to them with labels 1, 2, . . . , d, though our work is extensible to categorical data.

n parties, referred to as clients, where each client k=1, . . . , n receives (or has) data X^{k} of N^{k} samples from [symbol] *, that is, one or more samples in X^{k} have NA as the value for one or more features, are considered. Through the work, when k is not quantified, it refers to an arbitrarily chosen client unless mentioned otherwise. Now, for the data X^{k},

$${X}_{{f}_{i}}^{k}$$

denotes the values of feature f for the i-th sample in X^{k}, while

$${X}_{\_ f}^{k}$$

denotes the values of f for all the samples in X^{k}. And,

$${X}_{\_ f}^{k}$$

denotes the data for all the features but f. Note that for simplifying the exposition, the convention that the first subscript for the data refers to the feature was used.

R^{k} is used to denote the missing indicators of the data X^{k}, that is

$$\begin{matrix}{R}_{{f}_{i}}^{k} = 1 if {X}^{k} = \\ NA and {R}_{{f}_{i}}^{k} = 0\end{matrix}$$

otherwise. It said that a feature f is incomplete in X^{k} if one or more samples in X^{k} are missing values for f; similarly, f is incomplete in (X¹, . . . , Xⁿ) if f is incomplete for at least one client. A sample in X^{k} is f-unobservable if the value of the feature f is missing (i.e., is NA) in the sample; otherwise, the sample is called f-observable.

### B. Missing Mechanisms.

The client's data is from [symbol] *, although the original data comes from [symbol] (i.e., without any missing values). The standard approach of missing mechanism was used to describe this transformation, i.e., the data from without-missing values to with-missing values. A missing mechanism [symbol] for a feature f takes the data from [symbol] and outputs data in [symbol] *, that is, [symbol] _{f} (which can be probabilistic) generates missing values by replacing certain values of f by NA's. Missing mechanisms are categorized into two types based on how the generated missing values are related to the data. These categories are as follows.

MCAR (Missing Completely At Random): A missing mechanism is said to be missing completely at random (MCAR) if the distribution of missing values is independent of the underlying data distribution. As the missing values occur in a completely random manner, it has been shown in previous research that common imputation methods can effectively address this scenario. Accordingly, this mechanism is referred to herein as “simple missingness.”

Non-MCAR: A missing mechanism is referred to as non-MCAR when the distribution of missing values is influenced by the underlying data distribution. Two types of non-MCAR mechanisms are generally recognized. First, when the distribution of missing data is conditioned on observable data (i.e., features that are collected or observed by the client), the mechanism is classified as missing at random (MAR). Second, when the distribution of missing data is conditioned on unobservable data (i.e., features that are not observed or collected by the client), the mechanism is classified as missing not at random (MNAR). Among the non-MCAR mechanisms, MNAR is commonly encountered in real-world datasets.

In this work, attention is focused on MNAR mechanisms, i.e., it is assumed that the missing values in feature f in client k's data are generated by an MNAR mechanism

$${ℳ}_{f}^{k} .$$

It is noted that the MNAR settings—also referred to as non-ignorable missingness—are Imputation via ICE in the Centralized Setting

In data analysis and machine learning, complete datasets are crucial. A common method to address missing values is imputation. The MICE/ICE (Imputation by Chained Equations) methods are popular for their effectiveness, simplicity, and efficiency. ICE employs feature-specific imputation models that are built based on inter-feature correlations to impute missing values. It then leverages iterative refinement of missing value estimates to capture the joint distribution of missing data across multiple features, thereby ensuring accurate imputations under complex missing data scenarios. ICE typically uses linear regression to learn imputation models, which is both effective and efficient, making it a preferred choice for handling missing data, though it can be modified to use neural networks and random forests as well. Here, the following ICE approach (simplified from MICE) is considered in a centralized setting, in which all data is assumed to be available at a single site. The details of the ICE approach are illustrated in FIG. 2. Initialization: The missing values are initially imputed using simple techniques, such as mean or median substitution.

Iterative Imputation Process: Each iteration consists of imputing each incomplete feature f in a sequential manner.
(a) Learning the imputation model for f: The algorithm treats f as the target and the remaining features as predictors. A linear regression model is then fitted on the f-observable samples of the target feature.
(b) Updating imputations for f: The missing values in f are then imputed (or updated) using the newly fitted model.
(c) Cycling through incomplete features: (a) and (b) are repeated for each incomplete feature using the most recently imputed data for fitting the model in part (a).

Convergence: Once the process converges, meaning that subsequent imputations do not significantly change, the last dataset, with all missing values imputed, is the final imputed dataset.

### Problem Setup and Proposed Method

### A. Problem Formulation

Consider a distributed data networks comprising n clients, indexed by the set [symbol] ={1, 2, . . . , n}. Each client k∈ [symbol] holds a local dataset X^{k}∈ [symbol] ⁿ^{ₖ}^{×p}, where nₖ denotes the number of samples and p the number of features. All clients' data are assumed to be independently and identically distributed (i.i.d.) draws from a common data universe [symbol] *. Notably, the observations in X^{k} may be incomplete due to missing values. In the present disclosure, a missingness scenario is considered in which the majority of clients within the network are characterized by a nonignorable missingness mechanism, specifically missing-not-at-random (MNAR). This subset of clients is denoted as [symbol] _{N}⊂ [symbol] . The remaining subset of clients, denoted as [symbol] _{N}⊂ [symbol] , is characterized by either missing-completely-at-random (MCAR) missingness or the absence of missing data.

The primary objective addressed herein is the development of a federated imputation methodology configured to accurately impute missing values across all clients, with particular emphasis placed on clients associated with the challenging nonignorable (MNAR) missingness mechanism.

### B. Federated ICE and its Limitations

Federated learning (FL) enables building models over distributed data. To create the federated version of ICE, parts (a) and (b) of the iterative process (in the centralized ICE, described above) are done differently. Here, for each feature f, each client learns the imputation models on its data, and sends its model to a designated party, called the aggregator. The aggregator computes a global model by taking a weighted average of all the received models and sends the global model back to the clients. Each of the clients uses the received global model to impute the feature f to prepare for the next incomplete feature or round.

A basic federated imputation method is described, and the limitations of the existing approaches in dealing with heterogeneous non-MCAR missing mechanisms are discussed. [symbol] be the set of incomplete features across X¹, . . . , Xⁿ. To leverage the data federation, the clients collaborate in building the ICE imputation model over the federated data as follows. In each round t=1, . . . , T:
1) Each client k updates its imputation model for each f∈ [symbol] : Client k starts with the imputation models from the last round (one for each f∈ [symbol] ), and learns the imputation models

$$( {θ}_{f}^{k}$$

for every

$$f {∈}_{𝒻} ℱ )$$

for the current round using its local data (X^{k}). The client k then sends the updated imputation models to the aggregator.
2) The aggregator performs federated averaging: The aggregator receives the imputation Models

$$( {θ}_{f}^{1} , … , {θ}_{f}^{n}$$

for each f∈ [symbol] ) from all the clients. It then aggregates the models, e.g., by taking a uniform or weighted average, and sends the aggregated model back to the clients.

Note that for each feature, all clients share the same global model in this approach. Federated averaging is the most crucial step. Many innovative solutions have been constructed by considering different meaningful weighting schemes. In vanilla federated averaging, all the local models are weighted proportionally to their training samples (TS)-size.

However, this solution is merely an extension of the centralized ICE approach into a federated setting, and as such, it inherits the limitations of centralized ICE imputation, particularly with respect to MNAR missingness. Previous work demonstrates that vanilla ICE imputation works effectively only under ignorable missing data conditions (MCAR/MAR) because it relies on models trained on observed (i.e., f-observable) samples to impute missing values. Under MNAR missingness, however, the probability of missingness is correlated with unobserved data, leading to a discrepancy between the distribution of observed samples and that of the missing data. Consequently, the ICE imputation can deviate from the true underlying distribution. In scenarios where the majority of clients in a distributed network exhibit MNAR missingness, federated ICE usually fails to provide optimal imputation for each client (this is confirmed in our preliminary experimental evaluation).

### C. Proposed Framework: ICE via Knowledge Transfer

Our approach leverages clients with complete data or simple missingness (e.g., MCAR) to improve imputation for those clients with MNAR missingness. In clients with complete data or simple missingness, empirical evidence shows that their imputation models learned on observed data can accurately recover the true distribution of missing values. Assuming that the data are IID across clients, the knowledge obtained from clients with complete or MCAR data conditions can be used as the references for those clients with MNAR missingness. Furthermore, since knowledge is transferred solely through the exchange of model parameters, data privacy is preserved. Based on this strategy, a solution is introduced: the Knowledge Transfer-based Imputation via Collaborative Estimation (KT-ICE) framework.

In this section, the general framework of the proposed solution, referred to as the knowledge transfer-based ICE (KT-ICE) imputation framework, is outlined. Initially, the set of clients C is grouped into two sets according to the simplicity of their missing data conditions. Clients exhibiting simple missingness—namely, those with missing completely at random (MCAR) or no missing data—are grouped into [symbol] _{S}; those exhibiting missing-not-at-random (MNAR) missingness are grouped into [symbol] _{N}. This classification can be implemented using established missing mechanism tests, such as Little's test or a regression-based test. Then, the overall workflow of KT-ICE is decomposed into two stages:

Inter-Feature Knowledge Extraction & Transfer from [symbol] _{S}: In the first stage, the knowledge of inter-feature relationships is extracted from clients exhibiting simple missing conditions and is utilized as a reference for imputing missing values for clients characterized by MNAR missingness. Firstly, clients in [symbol] _{S} need to perform collaborative imputation using a standard federated imputation algorithm (e.g., Federated ICE). The goal of this step is to obtain complete data for these clients. Due to the simplicity of their missing data condition, accurate imputation is typically achievable in this stage.

Upon completion of the collaborative imputation phase, the complete datasets from clients in [symbol] _{S} are leveraged to extract transferable knowledge regarding inter-feature relationships. Specifically, each client in [symbol] _{S} trains regression models for each feature using the remaining features as predictors to capture the conditional dependencies among them. These local regression models are subsequently aggregated via federated averaging, resulting in global regression models whose parameters encode the global inter-feature relationships. This aggregated knowledge, embodied in the global model parameters, serves as a reference that is transmitted to clients in [symbol] _{N} to guide and enhance their local imputation processes.

Local Personalized Imputation for [symbol] ₛ: In the final stage, the global regression model parameters—encoding the global inter-feature relationships extracted from [symbol] ₛ—are transmitted to the clients in [symbol] _{N}. Each MNAR client then incorporates this transferred knowledge as a reference to refine and adjust its local imputation model for each feature. To this end, two strategies are proposed for effectively integrating global knowledge into local models. In one strategy, a novel mixing mechanism is employed, by which imputation accuracy is substantially enhanced. Detailed descriptions and theoretical justifications for these strategies are provided in the sections that follow.

Algorithm 1: General Framework of KT-ICE

| | Input: Client set [symbol] , data w/missingness {X^{k}: k ∈ [symbol] } |
|---|---|
| | Output: Imputed data {\tilde{X}^{k} ∈ [symbol] } |
| | Initialization: |
| 1 | Group clients [symbol] into [symbol] _{S} with simple missingness and [symbol] _{N} with MNAR missingness |
| 2 | Each client k computes missing mask R^{^{k}}from X^{^{k}} |
| 3 | Get incomplete feature set F ← Incomplete-Features(X¹, . . . , X^{k}) |
| | Inter-feature Knowledge Extration & Transfer from [symbol] _{S}: |
| 4 | {\tilde{X}^{k}: k ∈ [symbol] s} ← Federated-ICE-Impute({X^{k}: k ∈ [symbol] s}, {R^{k}: k ∈ [symbol] s}) |
| 5 | for each feature f ∈ F do |
| 6 | Each client k trains linear regression model based on $\{ {\tilde{X}}_{f}^{k} , {\tilde{X}}_{- f}^{k} \}$ |
| | and gets parameter θ^{k} |
| 7 | The server collects and aggregates model parameters {θ^{k}: k ∈ [symbol] s} |
| | based on federated averaging algorithm to get global inter-feature knowledge \tilde{θ}_{f} |
| 8 | end |
| 9 | The server broadcast global inter-feature knowledge {\tilde{θ}_{f}: f ∈ [symbol] } to clients [symbol] _{N} |
| | Local Personalized ICE Imputation for [symbol] _{N}: |
| 10 | for each client k ∈ [symbol] _{N} do |
| 11 | Set global knowledge as Θ = {\tilde{θ}_{f}: f ∈ [symbol] } |
| 12 | \tilde{X}^{k} ← KT-ICE(\tilde{X}^{k}, R^{k}, Θ) |
| 13 | end |

Inter-Feature Knowledge Extraction & Transfer from [symbol] ₛ:

In this section, the rationale and procedure for extracting inter-feature relationships from clients is described with simple missingness ( [symbol] ₛ). Recall that in ICE imputation, the algorithm iteratively refines imputation models for each feature. For each feature f the corresponding imputation model is trained on its f-observable samples using all other features as predictors, thereby learning the conditional relationships between f and the remaining features. In the prediction phase, these learned inter-feature conditional relationships are used to impute the missing values of the f-unobservable samples, forming the foundation of ICE imputation.

However, for clients with missing-not-at-random (MNAR) missingness, the f-observable samples tend to be non-i.i.d. from the f-unobservable samples. Consequently, the relationships learned solely from an MNAR client's f-observable samples may be biased or shifted from true relationships of f-unobservable samples, leading to suboptimal imputation.

However, remember that in the networks, there is still a small subset of clients with simple missing conditions ( [symbol] ₛ). If effective imputation is first performed by these clients—such as through a federated imputation approach—to obtain complete datasets that closely approximate the ground-truth data, then, due to the independent and identically distributed (IID) nature of the data across clients, the resulting complete datasets may be utilized as a reliable source from which accurate inter-feature relationships can be extracted for use by clients exhibiting MNAR mechanisms. Transferring this knowledge from [symbol] ₛ to MNAR clients [symbol] _{N} can, therefore, significantly enhance their imputation performance.

Then, the question is how to extract the knowledge of inter-feature relationships from [symbol] ₛ. The following procedure is proposed, involving two main steps:

Local Relationship Modeling: The basic idea is to let each client (k∈ [symbol] ₛ) train a set of regression models on its imputed complete data to capture the inter-feature relationships. Specifically, for every feature (f∈ [symbol] ) and every client k∈ [symbol] ₃, a linear regression model is trained on its local data (X^{k}) to predict f-th feature

$$( {X}_{f}^{k} )$$

from all other feature

$$( {X}_{\_ f}^{k} ) .$$

Then, the parameters

$$( {θ}_{f}^{k} )$$

of the regression model exactly capture the local inter-feature relationship between f and the remaining features for each client.

Global Knowledge Aggregation: In this step, the server gathers all local parameters

$$( {θ}_{f}^{k} )$$

for each feature f from all clients in [symbol] ₛ. Then, federated averaging is employed to aggregate the local parameters into a global model parameter (\tilde{θ}_{f}). This \tilde{θ}_{f} synthesizes the relationship information from all participating clients in [symbol] ₛ. Then, the complete set of these global parameters, {\tilde{θ}_{f}: f∈ [symbol] }, constitutes the transferable knowledge of more reliable inter-feature relationships. This knowledge, distilled from the clients with more reliable data characteristics, is finally transferred to MNAR clients to enhance their local imputation model accuracy.
D. Local Personalized Imputation for [symbol] _{N}.

In this section, the details of the KT-ICE imputation method are described. The pseudo code of the algorithm is illustrated in FIG. 2. For clients with MNAR missingness, the basic flow of the local imputation process follows a similar structure to the ICE imputation framework. The process begins with initializing missing values using simple imputation methods such as mean or median, followed by an iterative imputation procedure that sequentially processes each incomplete feature f (as illustrated in 2). For each feature, the imputation process involves learning an appropriate imputation model for feature f and then applying this model to update the imputed values. This iteration continues until convergence, at which point the final imputed dataset is obtained.

The critical differences between KT-ICE and traditional ICE lie in how MNAR clients leverage transferred knowledge—specifically, the regression model parameters for each feature {\tilde{θ}_{f}: f∈ [symbol] } obtained from [symbol] _{S} clients—by integrating this knowledge into their local ICE imputation procedures to mitigate the bias introduced by MNAR missingness, they can improve their imputation accuracy. Our proposed strategy gives an optimal way to integrate the global model into the local imputation model with strong theoretical guarantees.
a) Global and Local Imputation Model: Let us first examine the imputation process for the ICE algorithm in detail. In each iteration of ICE imputation for feature f the client utilizes the most recently imputed data, \tilde{X}, and partitions it into A and B, corresponding to the f-observable samples and f-unobservable samples, respectively.

In traditional ICE imputation, a local imputation model is constructed by applying linear regression on f-observable samples, with dependent variable Y=A_{f} and independent variables X=A_{-f}. This model is then used to impute the missing values in f-unobservable samples B. However, due to the non-i.i.d. relationship between f-observable and f-unobservable samples for MNAR clients, this model trained solely on f-observable samples produces biased imputation results.

Because global knowledge is available from the set of clients [symbol] _{S}, a global imputation model may be constructed by initializing a linear regression model having the same specification as the local imputation model. The parameters of the global imputation model are set based on the global knowledge \tilde{θ}_{f} that is transferred from clients in C_{S}, which are characterized by simpler missing data conditions. One approach would be to directly use the global imputation model instead of the local imputation model for imputation, which is called KT-ICE-Global. In this case, for each sample x∈B_{f} with observable features x_{-f} and missing value x_{f}, the imputed value as \tilde{x}_{f}= [symbol] _{f}(x_{-f}) is determined directly. While this approach provides a more reliable solution than using only the local model, it completely disregards the local information encapsulated in the f-observable samples.

Actually, as will be shown below, through the theoretical analysis of the conditional probability of the missing feature given the observed features, it was found that an optimal approach for imputation in B_{f} is to combine both the global and local imputation models, rather than relying exclusively on one of them. Specifically, the analysis shows that an optimal combination of global and local imputation models can be obtained by incorporating a missing propensity term. This insight forms the basis for designing our optimal imputation strategy.
b) Theoretical Analysis of Optimal Imputed Values: In an iteration of ICE imputation, let be the current imputed dataset. The missingness indicator for feature f denoted by R_{f}∈{0,1}ⁿ where

$${R}_{f}^{i} = 1$$

if feature f is missing, otherwise it is observed. The data \tilde{X} can be partitioned based on R_{f} into two parts:
A_{f}: Subset of samples where f is observed

$$( {R}_{f}^{i} = 1$$

f-observable samples).
B_{f}: Subset of samples where f is missing

$$( {R}_{f}^{i} = 0 ,$$

f-unobservable samples).

For a sample x∈B_{f}, let x_{-f} denote the vector of all features except f, and x_{f} the missing value to be imputed. Define X_{f} as the random variable for feature f and X^{-f} as the random vector of all other features. Our objective is to compute [symbol] [X_{f}|X_{-f}=x_{-f}, R_{f}=1] to give imputation for missing samples in X_{f} given X_{f} taking value of x_{-f}. The following notations were introduced:
[symbol] ^{unobs}(X_{f}|X_{-f}=x_{-f})= [symbol] [X_{f}|X_{-f}=x_{-f}, R_{f}=1]: Conditional expectation of X_{f} for f-unobservable samples in B_{f} given X_{-f} taking value of x_{-f}.
[symbol] ^{obs}(X_{f}|X_{-f}=x_{-f})= [symbol] [X_{f}|X_{-f}=x_{-f}, R_{f}=0]: Conditional expectation of X_{f} for f-observable samples in B_{f} given X_{-f} taking value of x_{-f}.
[symbol] ^{gt}(X_{f}|X_{-f}=x_{-f})= [symbol] [X_{f}|X_{-f}=x_{-f}]: Conditional expectation of X_{f} for ground truth data in B_{f} given X_{-f} taking value of x_{-f}.
α(x_{-f})=Pr(R_{f}=1|X_{-f}=x_{-f}): Propensity score of missing feature f given X_{-f} taking value of x_{-f}.

The following theorem is presented for the optimal imputed value for missing data of the sample in B_{f}.

Theorem 1: For a sample x∈B_{f}, the optimal imputed value for the missing feature f is:

$$\begin{matrix}{𝔼}^{unobs} ( {X}_{f} \vert {X}_{\_ f} = {x}_{\_ f} ) = \\ \frac{1}{α ( {x}_{\_f} )} {𝔼}^{gt} ( {X}_{f} \vert {X}_{\_ f} = {x}_{\_ f} ) + \\ ( 1 - \frac{1}{α ( {x}_{\_ f} )} ) {𝔼}^{obs} ( {X}_{f} \vert {X}_{\_ f} = {x}_{\_ f} )\end{matrix}$$

$$where α ( {x}_{\_ f} ) = Pr ( {R}_{f} = 1 \vert {X}_{\_ f} = {x}_{\_ f} )$$

This theorem derives a relationship between the conditional expectations, which informs the optimal imputation strategy. It shows that the optimal imputation for missing values of f-unobservable samples is a weighted combination of the true conditional expectations and conditional expectations in f-observable samples, modulated by the propensity score α(x_{-f})
c) Knowledge Transfer via Mixing of Global and Local Models: Based on 1, for a sample x∈B_{f}, with observable features x_{-f}, optimal imputation of the missing value x_{f} requires estimating three components: [symbol] ^{gt}(X_{f}|X_{-f}=x_{-f})= [symbol] [X_{f}|X_{-f}=x_{-f}], and α(x_{-f}). These components can be approximated using a data-driven approach, in which appropriate models are learned from the data and subsequently aggregated in an optimal manner based on the principles described in Section 1. This solution is referred to as KT-ICE-Mixed, which constitutes the primary algorithm disclosed herein.

Specifically, in each iteration of ICE imputation for feature f, the client takes the most recently imputed data, \tilde{X}, and partitions it into A and B, which correspond to the f-observable samples and f-unobservable samples, respectively. Then, three models were first constructed for estimating [symbol] ^{gt}(X_{f}|X_{-f}=x_{-f}), [symbol] ^{obs}(X_{f}|X_{-f}=x_{-f}), and α(x_{-f}) respectively as follows:

Local Imputation Model ( [symbol] _{f}): Built by applying linear regression on f-observable samples, with dependent variable Y=A_{f} and independent variables X=A_{-f}. Since [symbol] is trained on f-observable samples, it can be used to estimate [symbol] ^{obs}(X_{f}|X_{-f}=x_{-f}).

Global Imputation Model ( [symbol] ): Initialized as a linear regression model following the same specification as the local imputation model, but set its parameters to the global knowledge \tilde{θ}_{f} transferred from clients in [symbol] ₛ with simple missing conditions. Due to the i.i.d data assumption between [symbol] ₛ and [symbol] _{N}, this model provides an estimate of [symbol] ^{gt}(X_{f}|X_{-f}=x_{-f}).

Missing Propensity Model ( [symbol] _{f}): Constructed using logistic regression with

$$X = {\tilde{X}}_{\_ f}^{k}$$

to predict the missing indicator

$$Y = {R}_{f}^{k}$$

to estimate the probability of missingness given input values α(x_{-f}).

After the three models have been obtained, they can be combined to provide an accurate imputation based on 1. In the imputation phase, for each sample x∈B_{f} with observable features x_{-f} and missing value x_{f}, the optimal imputed value was determined by leveraging our constructed models. Specifically, we input x_{-f} into each model to obtain the following approximations: [symbol] ^{obs}(X_{f}|X_{-f}=x_{-f})≈ [symbol] _{f}(x_{-f}), [symbol] ^{gt}(X_{f}|X_{-f}=x_{-f})≈ [symbol] _{f}(x_{-f}), and α(x_{-f})≈ [symbol] _{f}(x_{-f}). Then, following 1, the optimal imputation strategy was formulated, termed KT-combination, which combine these models as follows:

$${x}_{f} = \frac{1}{{𝒫}_{f} ( {x}_{\_ f} )} {𝒢}_{f} ( {x}_{\_ f} ) + ( 1 - \frac{1}{{𝒫}_{f} ( {x}_{\_ f} )} ) {ℒ}_{f} ( {x}_{\_ f} )$$

This formulation represents a theoretically grounded approach to combining local and global inter-feature relationships weighted by the estimated propensity score for missingness to derive optimal imputed values for MNAR clients. The empirical results presented in IV further validate the efficacy of this approach, demonstrating its superior performance across multiple evaluation metrics.

Algorithm 2: KT-ICE Imputation

Input: Data w/misses and mask X, R for client k, global model parameters {\tilde{θ}_{f}: f ∈ [symbol] }

| | Output: Imputed data \tilde{X} for client k |
|---|---|
| 1 | Initialization: Impute X using mean imputation and get initial imputed data X |
| 2 | repeat |
| 3 | for each feature f ∈ [symbol] do |
| 4 | A, B ← Partition(\tilde{X}, R_{f}) |
| | //Construct local imp model |
| 5 | ${ℒ}_{f}^{k} ← Linear - Reg . fit ( {A}_{f} , {A}_{\_ f} )$ |
| | //Construct global imp model |
| 6 | ${𝒢}_{f}^{k} ← Linear - Reg . init ( {\tilde{θ}}_{f} )$ |
| | //Construct missing propensity model |
| 7 | ${𝒫}_{f}^{k} ← Log it - Reg . fit ( {R}_{f} , )$ |
| | //Imputation using KT combination |
| 8 | \tilde{B} ← θ |
| 9 | for each sample x ∈ B do |
| 10 | \tilde{x}_{f} = KT-combination( [symbol] _{f}, [symbol] _{f}, [symbol] _{f}, x_{-f}) |
| 11 | \tilde{B} ← \tilde{B} ∪ {(x_{f}, x_{-f})} |
| 12 | end |
| 13 | \tilde{X} = Concatenate(A, \tilde{B} |
| 14 | end |
| 15 | util end |

### Empirical Evaluation

### A. Experimental Setup

Datasets: Our experimental evaluation employs eight medical datasets from public repositories, comprising four for classification tasks and four for regression tasks. Table III provides a detailed summary of these datasets a

TABLE III
Dataset Summary. Summary of datasets, including the number
of samples, number of features, prediction task type
(classification [clf] or regression [reg]),
and number of classes for classification tasks

| Datasets | #Samples | #Features | Task Type | #Classes |
|---|---|---|---|---|
| codrna | 20,000 | 8 | clf | 2 |
| codon | 12,843 | 35 | clf | 11 |
| nhanesgh | 6,134 | 17 | clf | 2 |
| cdc | 2,000 | 7 | clf | 2 |
| parkinsons | 5,731 | 19 | reg | — |
| support | 8,624 | 17 | reg | — |
| hhnp | 18,938 | 29 | reg | — |
| dvisits | 5,039 | 7 | reg | — |

Missing Data Simulation & Federated Data Scenarios: In the experimental setup, a federated data network was constructed comprising ten clients, each of which was assigned an independent and identically distributed (iid) sample drawn from a central dataset. The sample sizes across the clients were randomly varied between 1,000 and 1,500. A realistic scenario of missing data in distributed networks was considered, wherein a small subset of clients was configured to have either complete data or simple missing mechanisms (i.e., missing completely at random, MCAR), while the majority of clients were configured to exhibit more complex missing mechanisms (i.e., missing not at random, MNAR). Specifically, the preliminary experimental design included two clients with simple missing data conditions-one configured with no missing data and the other with MCAR missingness—while the remaining eight clients were assigned MNAR missingness conditions.

Missing data were systematically introduced across all clients using the following methodology. For each client's local dataset, 50% of the features were randomly selected, and missing values were introduced with feature-specific missing ratios ranging from 30% to 50%. The methodology employed for simulating missing data was based on established protocols as described in prior research. MCAR conditions were simulated by applying a Bernoulli distribution to each selected feature, wherein values were masked randomly according to the predetermined missing ratio. MNAR conditions were simulated using a logistic regression-based approach, referred to herein as the Logit-based mechanism. In this method, missing values were generated through a logistic model in which the corresponding feature served as the predictor variable. As a result, the probability of missingness was made dependent on the actual values of the feature, thereby replicating realistic MNAR scenarios.

Baselines: Our experimental evaluation compares the proposed methods, KT-ICE-Global and KT-ICE-Mixed, against two ICE-based imputation approaches:
(1) LocalICE, which represents a non-federated solution wherein each client performs ICE imputation independently on its local dataset, without any inter-client collaboration.
(2) FedICE, which implements a federated ICE framework that utilizes sample size weighted one-shot averaging for model aggregation across federated clients.

Evaluation Metrics: To assess imputation quality, multiple metrics were employed: (1) RMSE (root mean square error), which quantifies the deviation between imputed and actual values; (2) Sliced-WS (sliced Wasserstein distance), which measures distributional similarity between imputed and original data. and (3) t-SNE (t-distributed Stochastic Neighbor Embedding) visualizations to qualitatively examine the preservation of data structure. Lower values of RMSE and Sliced-WS indicate superior imputation performance.

Additionally, the practical utility of the imputation is evaluated through downstream federated prediction tasks performed on the imputed datasets. For classification tasks, F1-scores are reported, whereas for regression tasks, mean squared error (MSE) is utilized. All performance metrics are calculated using independently and identically distributed (i.i.d.) test sets to ensure that the evaluation remains unbiased.

To ensure a comprehensive evaluation, multiple federated prediction models were implemented: (1) FedLR (federated logistic regression), which was trained using distributed stochastic gradient descent optimization via the FedAvg protocol; (2) FedSVM (federated support vector machine), in which aggregated support vectors were utilized; and (3) FedNN (federated two-layer neural network), which was trained using the FedAvg protocol.

Implementation Details: The federated imputation algorithms described herein were implemented by extending the Iterative Imputer module available in the scikit-learn library. LASSO regression and logistic regression were utilized as the underlying imputation model and missing probability prediction model, respectively. The convergence threshold for the imputation iteration was set to 0.001. For the downstream federated prediction models, the implementation was developed by adapting the reference algorithm made available through the NVIDIA FLARE federated learning platform. To ensure statistical robustness, each experimental configuration was independently replicated ten times using distinct random seeds, and the results reported herein represent the average across these replications.

FIG. 2: Imputation Quality. Ridgeline plot shows distribution of imputation quality ((a) for RMSE and (b) for sliced Wasserstein distance between imputed data and ground-truth data) for clients with MCAR missingness, MNAR missingness, and all clients across all datasets. Average imputation quality across all clients shows beside

### B. Results

Imputation Quality: FIG. 2 presents a comprehensive evaluation of imputation quality across all datasets, illustrating both RMSE and sliced Wasserstein distance metrics for MCAR clients, MNAR clients, and the entire client population. The experimental results demonstrate that both KT-ICE-Global and KT-ICE-Mixed significantly outperform the baseline approaches for MNAR clients and across the entire client population with respect to both evaluation metrics. This performance differential underscores the efficacy of leveraging global knowledge from MCAR clients to enhance imputation quality for MNAR clients. Notably, our proposed KT-ICE-Mixed approach exhibits superior performance compared to the naive knowledge transfer strategy (KT-ICE-Global), achieving a substantial reduction in average RMSE from 0.146 to 0.105 across all datasets. These empirical findings validate that our proposed methodology of integrating global and local imputation models yields more accurate imputation results, thereby corroborating the theoretical optimality established in III-E through practical validation.

Federated Prediction: Table IV and Table V present the performance results of federated pre-diction on imputed datasets using three federated prediction models (FedLR, FedSVM, and FedNN). The experimental results demonstrate that the enhanced imputation quality achieved by our proposed methods results in significant improvements in downstream federated prediction performance for both classification and regression tasks. For the codrna dataset, KT-ICE-Mixed imputation yields a substantial improvement in federated SVM performance, with an increase of 9.7% compared to the Fed-ICE baseline and 4% compared to the naive KT-ICE-Global approach. Similarly, for the parkinsons dataset, our KT-ICE-Mixed method reduces MSE by 29.5% relative to Fed-ICE and by 11.4% compared to naive KT-ICE-Global. These results underscore the efficacy of our proposed methodology in addressing missing data challenges within clients' local datasets for federated learning tasks.

TABLE IV
Federated prediction performance on imputed classification datasets. F1-Score
(higher is better) were reported, and the best results are highlighted in bold.

| | codrna | | | codon | | | nhanesgh | | | cdc | | |
|---|---|---|---|---|---|---|---|---|---|---|---|---|
| | LR | SVM | NN | LR | SVM | NN | LR | SVM | NN | LR | SVM | NN |
| Local-ICE | 72.7 | 79.7 | 74.4 | 50.3 | 73.1 | 60.3 | 44.9 | 51.5 | 46.6 | 71.5 | 59.6 | 64.5 |
| Fed-ICE | 75.3 | 82.0 | 82.1 | 51.0 | 73.2 | 63.2 | 44.5 | 52.3 | 53.1 | 72.6 | 61.7 | 67.7 |
| KT-ICE-Global | 86.3 | 87.7 | 90.8 | 51.4 | 74.8 | 70.1 | 53.3 | 60.1 | 56.3 | 73.4 | 67.5 | 68.1 |
| KT-ICE-Mixed | 89.3 | 91.7 | 92.9 | 52.1 | 75.3 | 71.7 | 59.5 | 63.4 | 59.4 | 73.6 | 68.4 | 68.9 |

TABLE V
Federated prediction performance on imputed regression datasets. Mean squared
error (MSE) is reported (lower values indicate better performance), with
the best results shown in bold. For clarity of presentation, the results
for support and dvisits have been scaled by a factor of 10.

| | parkinsons | | | support | | | hhnp | | | dvisits | | |
|---|---|---|---|---|---|---|---|---|---|---|---|---|
| | LR | SVM | NN | LR | SVM | NN | LR | SVM | NN | LR | SVM | NN |
| Local-ICE | 107.2 | 96.0 | 103.2 | 4.86 | 4.55 | 5.35 | 1.80 | 1.81 | 1.82 | 3.53 | 3.43 | 3.63 |
| Fed-ICE | 106.0 | 94.1 | 93.8 | 5.04 | 4.59 | 5.33 | 1.95 | 1.82 | 1.81 | 3.53 | 3.40 | 3.56 |
| KT-ICE-Global | 102.1 | 88.0 | 75.7 | 4.91 | 4.29 | 4.77 | 1.87 | 1.77 | 1.73 | 3.52 | 3.38 | 3.44 |
| KT-ICE-Mixed | 100.2 | 83.3 | 64.3 | 4.76 | 4.27 | 4.61 | 1.65 | 1.76 | 1.64 | 3.48 | 3.35 | 3.34 |

In the present disclosure, two novel ICE-based imputation approaches, referred to as KT-ICE-Global and KT-ICE-Mixed, are introduced. These approaches are configured to improve imputation quality for clients exhibiting missing-not-at-random (MNAR) data patterns through the application of knowledge transfer mechanisms. Within the federated network, knowledge represented by parameters of the imputation models is transferred from clients characterized by simpler missing data conditions to those exhibiting MNAR missingness.

This transferred knowledge is employed to adjust the output distributions of the imputation models on MNAR clients by means of a novel mixing strategy. Through this approach, the overall imputation quality across the federated network is enhanced.

Experimental evaluations were performed using multiple datasets. It was found that the proposed methods consistently outperformed both local ICE-based imputation techniques and existing federated ICE-based approaches. Statistically significant improvements were observed in terms of imputation accuracy as well as performance in downstream tasks. The methods and evaluation framework disclosed herein are intended to provide a practical solution to the challenges associated with MNAR missingness in real-world federated learning environments.

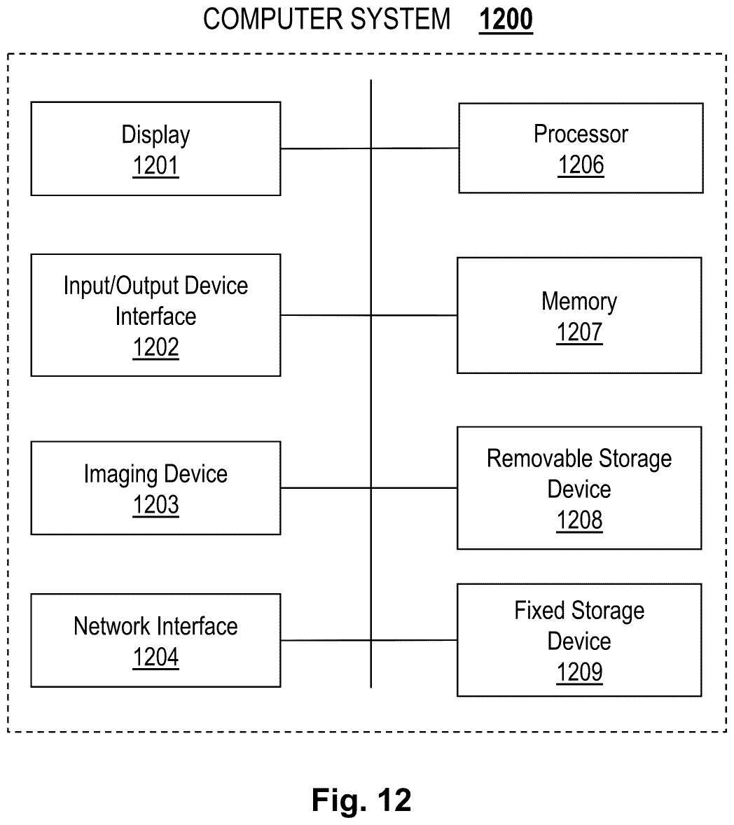

FIG. 12 is a functional diagram illustrating a programmed computer system in accordance with some embodiments. As will be apparent, other computer system architectures and configurations can be used to perform the described methods. Computer system 1200, which includes various subsystems as described below, includes at least one microprocessor subsystem (also referred to as a processor or a central processing unit (CPU) 1206). For example, processor 1206 can be implemented by a single-chip processor or by multiple processors. In some embodiments, processor 1206 is a general-purpose digital processor that controls the operation of the computer system 1200. In some embodiments, processor 1206 also includes one or more coprocessors or special purpose processors (e.g., a graphics processor, a network processor, etc.).

Using instructions retrieved from memory 1207, processor 1206 controls the reception and manipulation of input data received on an input device (e.g., image processing device 1203, I/O device interface 1202), and the output and display of data on output devices (e.g., display 1201).

Processor 1206 is coupled bi-directionally with memory 1207, which can include, for example, one or more random access memories (RAM) and/or one or more read-only memories (ROM). As is well known in the art, memory 1207 can be used as a general storage area, a temporary (e.g., scratchpad) memory, and/or a cache memory. Memory 1207 can also be used to store input data and processed data, as well as to store programming instructions and data, in the form of data objects and text objects, in addition to other data and instructions for processes operating on processor 1206. Also, as is well known in the art, memory 1207 typically includes basic operating instructions, program code, data, and objects used by the processor 1206 to perform its functions (e.g., programmed instructions). For example, memory 1207 can include any suitable computer-readable storage media described below, depending on whether, for example, data access needs to be bi-directional or uni-directional. For example, processor 1206 can also directly and very rapidly retrieve and store frequently needed data in a cache memory included in memory 1207.

A removable mass storage device 1208 provides additional data storage capacity for the computer system 1200 and is optionally coupled either bi-directionally (read/write) or uni-directionally (read-only) to processor 1206. A fixed mass storage 1209 can also, for example, provide additional data storage capacity. For example, storage devices 1208 and/or 1209 can include computer-readable media such as magnetic tape, flash memory, PC-CARDS, portable mass storage devices such as hard drives (e.g., magnetic, optical, or solid-state drives), holographic storage devices, and other storage devices. Mass storages 1208 and/or 1209 generally store additional programming instructions, data, and the like that typically are not in active use by the processor 1206. It will be appreciated that the information retained within mass storages 1208 and 1209 can be incorporated, if needed, in a standard fashion as part of memory 1207 (e.g., RAM) as virtual memory.

In addition to providing processor 1206 access to storage subsystems, bus 1210 can be used to provide access to other subsystems and devices as well. As shown, these can include a display 1201, a network interface 1204, an input/output (I/O) device interface 1202, an image processing device 1203, as well as other subsystems and devices. For example, image processing device 1203 can include a camera, a scanner, etc.; I/O device interface 1202 can include a device interface for interacting with a touchscreen (e.g., a capacitive touch sensitive screen that supports gesture interpretation), a microphone, a sound card, a speaker, a keyboard, a pointing device (e.g., a mouse, a stylus, a human finger), a global positioning system (GPS) receiver, a differential global positioning system (DGPS) receiver, an accelerometer, and/or any other appropriate device interface for interacting with system 1200. Multiple I/O device interfaces can be used in conjunction with computer system 1200. The I/O device interface can include general and customized interfaces that allow the processor 1206 to send and, more typically, receive data from other devices such as keyboards, pointing devices, microphones, touchscreens, transducer card readers, tape readers, voice or handwriting recognizers, biometrics readers, cameras, portable mass storage devices, and other computers.

The network interface 1204 allows processor 1206 to be coupled to another computer, computer network, or telecommunications network using a network connection as shown. For example, through the network interface 1204, the processor 1206 can receive information (e.g., data objects or program instructions) from another network, or output information to another network in the course of performing method/process steps. Information, often represented as a sequence of instructions to be executed on a processor, can be received from and outputted to another network. An interface card or similar device and appropriate software implemented by (e.g., executed/performed on) processor 1206 can be used to connect the computer system 1200 to an external network and transfer data according to standard protocols. For example, various process embodiments disclosed herein can be executed on processor 1206 or can be performed across a network such as the Internet, intranet networks, or local area networks, in conjunction with a remote processor that shares a portion of the processing. Additional mass storage devices (not shown) can also be connected to processor 1206 through network interface 1204.

In addition, various embodiments disclosed herein further relate to computer storage products with a computer-readable medium that includes program code for performing various computer-implemented operations. The computer-readable medium includes any data storage device that can store data that can thereafter be read by a computer system. Examples of computer-readable media include, but are not limited to: magnetic media such as disks and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code as produced, for example, by a compiler, or files containing higher level code (e.g., script) that can be executed using an interpreter.

The computer system as shown in FIG. 12 is an example of a computer system suitable for use with the various embodiments disclosed herein. Other computer systems suitable for such use can include additional or fewer subsystems. In some computer systems, subsystems can share components (e.g., for touchscreen-based devices such as smartphones, tablets, etc., I/O device interface 1202 and display 1201 share the touch-sensitive screen component, which both detects user inputs and displays outputs to the user). In addition, bus 1210 is illustrative of any interconnection scheme serving to link the subsystems. Other computer architectures having different configurations of subsystems can also be utilized.

### Additional Definitions

To aid in understanding the detailed description of the compositions and methods according to the disclosure, a few express definitions are provided to facilitate an unambiguous disclosure of the various aspects of the disclosure. Unless otherwise defined, all technical and scientific terms used herein have the same meaning as commonly understood by one of ordinary skill in the art to which this disclosure belongs.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

As used herein, the terms “memory,” “memory device,” “computer-readable storage medium,” “data store,” “data storage facility,” and the like each refer to a non-transitory device on which computer-readable data, programming instructions or both are stored. Except where specifically stated otherwise, the terms “memory,” “memory device,” “computer-readable storage medium,” “data store,” “data storage facility,” and the like are intended to include single device embodiments, embodiments in which multiple memory devices together or collectively store a set of data or instructions, as well as individual sectors within such devices.

As used herein, the terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The terms “instructions” and “programs” may be used interchangeably herein. The instructions may be stored in object code format for direct processing by the processor, or in any other computing device language, including scripts or collections of independent source code modules that are interpreted on demand or compiled in advance. Functions, methods, and routines of the instructions are explained in more detail below. The instructions may be any set of instructions to be executed directly (such as machine code) or indirectly (such as scripts) by the processor. For example, the instructions may be stored as computing device code on the computing device-readable medium.

In addition, the terms “unit,” “-er,” “-or,” and “module” described in the specification mean units for processing at least one function and operation, and can be implemented by hardware components or software components and combinations thereof.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

Aspects of the present disclosure are described herein with reference to flowchart illustrations and/or block diagrams of methods, apparatus (systems), and computer program products according to embodiments of the invention. In some embodiments, the flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Unless specifically stated otherwise, it is appreciated that throughout the disclosure, descriptions utilizing terms such as “obtaining,” “performing,” “receiving,” “computing,” “associating,” “assigning,” “traversing,” “calculating,” “determining,” “identifying,” “transforming,” “ranking,” “providing,” “transmitting,” or the like, refer to the action and processes of a computer system, or similar electronic computing device, that manipulates and transforms data represented as physical (or electronic) quantities within the computer system memories or registers or other such information storage, transmission or display devices.

As used herein, the term “logistic regression” is a regression model for binary data from statistics where the logit of the probability that the dependent variable is equal to one is modeled as a linear function of the dependent variables.

As used herein, the term “neural network” is a machine learning model for classification or regression consisting of multiple layers of linear transformations followed by element-wise nonlinearities typically trained via stochastic gradient descent and back-propagation.

The term “machine learning,” as used herein, refers to a computer algorithm used to extract useful information from a database by building probabilistic models in an automated way.

The term “regression tree,” as used herein, refers to a decision tree that predicts values of continuous variables.

As used herein, the term “if may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

It will be understood that, although the terms “first,” “second,” etc., may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

It is noted here that, as used in this specification and the appended claims, the singular forms “a,” “an,” and “the” include plural reference unless the context clearly dictates otherwise. The terms “including,” “comprising,” “containing,” or “having” and variations thereof are meant to encompass the items listed thereafter and equivalents thereof as well as additional subject matter unless otherwise noted.

The phrases “in one embodiment,” “in various embodiments,” “in some embodiments,” and the like are used repeatedly. Such phrases do not necessarily refer to the same embodiment, but they may unless the context dictates otherwise.

The terms “and/or” or “/” means any one of the items, any combination of the items, or all of the items with which this term is associated.

As used herein, the term “each,” when used in reference to a collection of items, is intended to identify an individual item in the collection but does not necessarily refer to every item in the collection. Exceptions can occur if explicit disclosure or context clearly dictates otherwise.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All methods described herein are performed in any suitable order unless otherwise indicated herein or otherwise clearly contradicted by context. In regard to any of the methods provided, the steps of the method may occur simultaneously or sequentially. When the steps of the method occur sequentially, the steps may occur in any order, unless noted otherwise.

In cases in which a method comprises a combination of steps, each and every combination or sub-combination of the steps is encompassed within the scope of the disclosure, unless otherwise noted herein.

Each publication, patent application, patent, and other reference cited herein is incorporated by reference in its entirety to the extent that it is not inconsistent with the present disclosure. Publications disclosed herein are provided solely for their disclosure prior to the filing date of the present invention. Nothing herein is to be construed as an admission that the present invention is not entitled to antedate such publication by virtue of prior invention. Further, the dates of publication provided may be different from the actual publication dates which may need to be independently confirmed.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for complementarity-adjusted federated averaging imputation, comprising:
(a) receiving, by a server device, a missing mechanism prediction model and a local data imputation model from each of a set of user devices, wherein the missing mechanism prediction model of a user device determines missing data of a feature in a dataset of the user device, and wherein the local data imputation model of the user device is configured to impute the missing data of the feature to the dataset of the user device;
(b) determining, by the server device, a complementarity score of the feature for the missing mechanism prediction model in each of the set of user devices based on pair-wise complementarity of data available for the feature in each of the user devices relative to the missing data for the feature of a reference user device in the set of user devices;
(c) generating for the feature by the server device an individualized federated averaging data imputation model specific to each of the set of user devices by performing complementarity-adjusted federated averaging on local data imputation models received from the set of user devices, wherein the complementarity-adjusted federated averaging comprises aggregating the local data imputation models and applying a weight to each of the local data imputation models based on the complementarity score of a corresponding missing mechanism prediction model;
(d) transmitting to each of the set of the user device the individualized federated averaging data imputation model specific to each of the set of the user devices, and updating the local data imputation model of each of the set of the user device based on the individualized federated averaging data imputation model; and
(e) imputing the missing data of the feature to the dataset of each of the set of the user devices by the updated local data imputation model.

2. The method of claim 1, comprising performing one or more iterations of steps (a)-(e) until the local data imputation model from an iteration converges with the local data imputation model from a succeeding iteration.

3. The method of claim 1, comprising determining the pairwise complementarity by Imputation via Chained Equations (ICE) modeling.

4. The method of claim 1, comprising imputing the missing data with a mean or median value.

5. The method of claim 1, comprising performing one or more iterations of steps (a)-(e) for missing data of one or more features in the dataset.

6. The method of claim 1, wherein the missing mechanism prediction model comprises a logistic regression model.

7. The method of claim 1, wherein the local data imputation model comprises a linear regression model.

8. The method of claim 1, wherein the local data imputation model comprises a ridge regression model.

9. The method of claim 1, wherein the missing mechanism prediction model or the local data imputation model comprises a machine learning model.

10. The method of claim 1, wherein the missing mechanism prediction model or the local data imputation model comprises a neural network, a convolutional neural network (CNN), a deep convolutional neural network (DCNN), a cascaded deep convolutional neural network, a simplified CNN, a shallow CNN, or a combination thereof.

11. The method of claim 1, comprising identifying a subset of user devices as likely having data that complements the missing data of the feature in the user device.

12. The method of claim 1, comprising performing one or more iterations of steps (a)-(e) on the subset of user devices for the missing data of the feature in the user device.

13. The method of claim 1, wherein the missing data comprises non-identically distributed data.

14. The method of claim 1, wherein the missing data comprises data missing completely at random (MCAR), data missing at random (MAR), or data missing not at random (MNAR).

15. The method of claim 1, wherein the missing data comprises non-MCAR data that a missing data distribution depends on an observable data distribution.

16. The method of claim 1, wherein the missing data comprises non-MCAR data that a missing data distribution depends on an unobservable data distribution.

17. The method of claim 1, wherein at least a subset of user devices in the set of user devices are located in different sites.

18. The method of claim 1, wherein the server device comprises one or more distributed units.

19. The method of claim 1, wherein data of the user device is not shared with another user device or the server device.

20. The method of claim 1, comprising determining a pair-wise complementarity score by:
$$Complementarity Score = \frac{1}{2} ( 1 - \frac{< {ξ}_{f}^{k} , {ξ}_{f}^{ℓ} >}{‖ {ξ}_{f}^{k} ‖ \cdot ‖ {ξ}_{f}^{ℓ} ‖} )$$
where
$${ξ}_{f}^{k} and {ξ}_{f}^{l}$$
denote the parameters of the missing mechanism models for feature f of client k and l, respectively, <⋅> denotes the vector product and ∥⋅∥ denotes the vector norm.

21. The method of claim 1, comprising determining a sample size-based complementarity score by:
$${s}^{l} = {N}_{f}^{l} / {M}_{f} and {M}_{f} = max {N}_{f}^{1} , {N}_{f}^{2} , … , {N}_{f}^{n}$$
where
$${N}_{f}^{1} … {N}_{f}^{n}$$
are sample size of each client. s^{l} is the sample size score of client l.

22. The method of claim 1, comprising determining a weighted average of the complementarity score by:
$${a}^{kℓ} ∝ α ( \begin{matrix}No . of f - observable \\ samples at ℓ\end{matrix} ) + ( 1 - α ) ( \begin{matrix}complementarity b / w \\ {ξ}_{f}^{k} and {ξ}_{f}^{ℓ}\end{matrix} )$$
where [symbol] is the weighted average of the score, α∈[0,1] denotes the weight assigned to the sample size-based score, which controls the relative importance/influence of sample size versus complementarity.

23. The method of claim 1, comprising determining a normalized weighted average of the complementarity score by:
$${w}^{kl} = {( {a}^{kl} )}^{β} / {\sum }_{j \neq k} {( {a}^{kj} )}^{β}$$
where w^{kl} is normalized weighted averaging of the complementarity score, a^{kl} is weighted averaging score, β is scale for normalization

24. The method of claim 1, comprising determining the individualized federated averaging data imputation model by:
$$Cafe - Ave ( k , f ) = γ \cdot {θ}_{f}^{k} + ( 1 - γ ) {\sum }_{ℓ \neq k} {w}^{kℓ} \cdot {θ}_{f}^{ℓ}$$
where
$${θ}_{f}^{k}$$
denotes the parameters of the imputation model for feature f of client k, [symbol] denotes the weighted average of the complementarity score, and γ is the hyper parameter to control the relative influence of the local model and the weighted averaged global model.

25. A system for complementarity-adjusted federated averaging imputation, comprising one or more processors configured to implement the method of claim 1.
